(19) United States
(12) Patent Application Publication
(10) Pub. No.: US 2024/0170648 A1
(43) Pub. Date: May 23, 2024

(54) METAL SALT COMPOSITE CATHODES FOR METAL AND METAL ION BATTERIES

(71) Applicant: Oregon State University, Corvallis, OR (US)

(72) Inventors: Xiulei Ji, Portland, OR (US); Mingliang Yu, Corvallis, OR (US)

(73) Assignee: Oregon State University, Corvallis, OR (US)

(21) Appl. No.: 18/510,483

(22) Filed: Nov. 15, 2023

Related U.S. Application Data
(60) Provisional application No. 63/427,505, filed on Nov. 23, 2022.

(51) Int. Cl. H01M 4/36; H01M 4/04; H01M 4/62

(52) U.S. Cl. CPC H01M 4/364; H01M 4/0404; H01M 4/623; H01M 4/625; H01M 2004/028

(57) ABSTRACT

An metal composite cathode includes a composite of (i) a first component comprising one or more metal salts, wherein each metal salt is an alkali metal salt or an alkaline earth metal salt comprising M where M is Li, Na, K, Mg, Ca, or any combination thereof, (ii) a second component comprising a transition metal, a transition metal sulfide, a transition metal carbonate, a transition metal halide, or any combination thereof, and (iii) a carbon additive. The composite cathode may be used in a metal battery or metal ion battery.

### CROSS-REFERENCE TO RELATED APPLICATION

This application claims the benefit of the earlier filing date of U.S. Provisional Application No. 63/427,505, filed Nov. 23, 2022, which is incorporated by reference herein in its entirety.

### FIELD

This disclosure concerns metal salt composite cathodes for use in metal and metal ion batteries.

### SUMMARY

This disclosure concerns metal salt composite cathodes for use in metal and metal ion batteries. A cathode as disclosed herein includes a composite of (i) a first component comprising one or more metal salts, wherein each metal salt is an alkali metal salt or an alkaline earth metal salt comprising M where M is Li, Na, K, Mg, Ca, or any combination thereof, (ii) a second component comprising a transition metal, a transition metal sulfide, a transition metal carbonate, a transition metal halide, or any combination thereof, and (iii) a third component comprising a carbon additive. In some implementations, the second component comprises Cu₂S, Cu₂O, Cu, Fe, MnCO₃, MnF₂, Mn, Ni, Co, V, Cr, FeS, FeS₂, or any combination thereof. In some aspects, M is Li, Na, K, or any combination thereof, and the cathode may have an M:Cu₂S molar ratio of 2 to 8; an M:Cu₂O molar ratio of 2 to 8; an M:Cu molar ratio of 1 to 4; an M:Fe molar ratio of 1 to 6; an M:MnCO₃ molar ratio of 1 to 4; an M:MnF₂ molar ratio of 1 to 4; an M:Mn molar ratio of 2 to 8; an M:Ni molar ratio of 2 to 8; an M:Co molar ratio of 1 to 6; an M:V molar ratio of 2 to 10; an M:Cr molar ratio of 1 to 6; an M:FeS molar ratio of 1 to 6; or an M:FeS₂ molar ratio of 1 to 6. In other aspects, M is Mg, Ca, or a combination thereof, and the cathode may have an M:Cu₂S molar ratio of 1 to 4; an M:Cu₂O molar ratio of 1 to 4; an M:Cu molar ratio of 0.5 to 2; an M:Fe molar ratio of 0.5 to 3; an M:MnCO₃ molar ratio of 0.5 to 2; an M:MnF₂ molar ratio of 0.5 to 2; an M:Mn molar ratio of 1 to 4; an M:Ni molar ratio of 1 to 4; an M:Co molar ratio of 0.5 to 3; an M:V molar ratio of 1 to 5; an M:Cr molar ratio of 0.5 to 3; an M:FeS molar ratio of 0.5 to 3; or an M:FeS₂ molar ratio of 0.5 to 3.

In some aspects, the cathode further includes a binder and/or conductive carbon. The cathode may include 70 wt % to 97 wt % of the composite, 2 wt % to 15 wt % of the binder, and 1 wt % to 15 wt % of the conductive carbon. In some implementations, the cathode further includes a current collector.

A method of making the disclosed cathodes includes combining (i) a first component comprising one or more anhydrous metal salts, wherein each anhydrous metal salt is an alkali metal salt or an alkaline earth metal salt comprising M where M is Li, Na, K, Mg, Ca, or any combination thereof, (ii) a second component comprising Cu₂S, Cu₂O, Cu, Fe, MnCO₃, MnF₂, Mn, Ni, Co, V, Cr, FeS, FeS₂, or any combination thereof, and (iii) a third component comprising a carbon additive to form a mixture, and milling the mixture to form a composite. The method may further include comprising combining the composite with a binder, conductive carbon, or a binder and conductive carbon to form a subsequent mixture. The subsequent mixture may be applied to a current collector.

A battery includes a cathode as disclosed herein, an anode, and an electrolyte. In some aspects, the anode comprises lithium metal, sodium metal, potassium metal, magnesium metal, calcium metal, graphite, silicon, SiO, a Si/C composite, Li₄Ti₅O₁₂, a transition metal oxide, a transition metal sulfide, a tin-based anode, or an antimony-based anode. The electrolyte includes a lithium salt, a sodium salt, a potassium salt, a magnesium salt, or a calcium salt, and a solvent.

The foregoing and other objects, features, and advantages of the disclosure will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

FIGS. 1A and 1B show the discharge-charge potential profiles of a Li₃PO₄·3/4Cu₂S cathode in a coin cell with a 1 M LiPF₆ in EC and DEC (diethyl carbonate) (1:1 by volume) electrolyte (FIG. 1A), and the cycling performance of the Li₃PO₄·3/4Cu₂S cathode in the coin cell (FIG. 1B).

FIGS. 2A and 2B show the discharge-charge potential profiles of a LiOH·1/4Cu₂S cathode in a coin cell with a 1 M LiPF₆ in DME (1,2-dimethoxyethane) and HFE (2,2,2-trifluoroethyl-3′,3′,3′,2′,2′-pentafluoropropyl ether) (1:3 by volume) electrolyte (FIG. 2A), and the cycling performance of the LiOH·1/4Cu₂S cathode in the coin cell (FIG. 2B).

FIGS. 3A and 3B show the discharge-charge potential profiles of a HCOOLi·1/4Cu₂S cathode in a coin cell with a 1 M LiPF₆ in DME and HFE (1:3 by volume) electrolyte (FIG. 3A), and the cycling performance of the HCOOLi·1/4Cu₂S cathode in the coin cell (FIG. 3B).

FIGS. 4A and 4B show the discharge-charge potential profiles of a CH₃COOLi·1/4Cu₂S cathode in a coin cell with a 1 M LiPF₆ in DME and HFE (1:3 by volume) electrolyte (FIG. 4A), and the cycling performance of the CH₃COOLi·1/4Cu₂S cathode in the coin cell (FIG. 4B).

FIGS. 5A and 5B show the discharge-charge potential profiles of a Li₂CO₃·Cu cathode in a coin cell with a 1 M LiPF₆ in EC and DEC (1:1 by volume) electrolyte (FIG. 5A), and the cycling performance of the Li₂CO₃·Cu cathode in the coin cell (FIG. 5B).

FIGS. 6A and 6B show the discharge-charge potential profiles of a Li₃PO₄·3/2Cu cathode in a coin cell with a 1 M LiPF₆ in EC and DEC (1:1 by volume) electrolyte (FIG. 6A), and the cycling performance of the Li₃PO₄·3/2Cu cathode in the coin cell (FIG. 6B).

FIGS. 7A and 7B show the discharge-charge potential profiles of a MnCO₃·Li₂CO₃ cathode in a coin cell with a 1 M LiPF₆ in EC and DEC (1:1 by volume) electrolyte (FIG. 7A), and the cycling performance of the MnCO₃·Li₂CO₃ cathode in the coin cell (FIG. 7B).

FIGS. 8A-8C show galvanostatic charge-discharge (GCD) potential profiles at 30 mA g⁻¹ of Fe/LiF (FIG. 8A), Fe/Li₃PO₄ (FIG. 8B), and IronPF (Fe/Li₃PO₄/LiF) (FIG. 8C) composite electrodes.

FIGS. 9A-9C show GCD potential profiles at 30 mA/g of Fe/LiF (FIG. 9A), Fe/Li₃PO₄ (FIG. 9B), and IronPF (FIG. 9C) for the 1^{st} cycle.

FIGS. 10A-10D show the electrochemical performance at 30 mA g⁻¹ of ternary composite electrodes (IronPF cathode) with different molar ratios of Li₃PO₄ and LiF: 1:2 (FIG. 10A), 1:1 (FIG. 10B), and 2:1 (FIG. 10C); FIG. 10D shows the GCD profiles of the IronPF cathode for the 11^{th} cycle with various molar ratios of LiF and Li₃PO₄ at 30 mA g⁻¹.

FIGS. 11A-11B show GCD potential profiles of IronPF at 60° C. with the current rates of 30 mA g⁻¹ (FIG. 11A) and 100 mA g⁻¹ (FIG. 11B).

FIGS. 12A-12D show cyclic voltammetry curves of Fe/LiF, Fe/Li₃PO₄, and IronPF composite electrodes at 0.2 mV/s (FIG. 12A); cycling performance of IronPF at 100 mA/g (FIG. 12B); the rate capability of Fe/LiF, Fe/Li₃PO₄, and IronPF composite electrodes (FIG. 12C); and the cycling performance of IronPF at 60° C. with the current rates of 30 mA g⁻¹ and 100 mA g⁻¹ (FIG. 12D).

FIG. 13 shows ex situ XRD patterns of the IronPF cathode at various SOC (pristine, fully charged (FC), and fully discharged FD)) of the IronPF∥Li cells in comparison with the precursors.

FIGS. 14A-14C show scanning tunneling electron microscopy (STEM) images and corresponding energy-dispersive X-ray (EDX) elemental mappings of the pristine IronPF cathode (FIG. 14A, scale bars 200 nm), fully charged IronPF cathode (FIG. 14B, scale bars 70 nm), and fully discharged IronPF cathode (FIG. 14C, scale bars 80 nm) during the first charge/discharge cycle.

FIG. 15 is a schematic diagram of a proposed operation mechanism of the iron-based metal salt composite cathode; CH=charging, DIS=discharging.

FIG. 16 is a STEM image of a fully charged IronPF cathode (scale bar 80 nm), an enlarged version of the STEM image in FIG. 14B.

FIG. 17 shows the electrochemical performance of a ball milled Li₃PO₄/graphite composite electrode with a current of 30 mA g⁻¹.

FIGS. 18A-18C show the Nyquist plots of galvanostatic electrochemical impedance spectroscopy (GEIS) spectra at different states of charge for three composite electrodes: IronPF (FIG. 18A), Fe/Li₃PO₄ (FIG. 18B), and Fe/LiF (FIG. 18C).

FIGS. 19A-19C are 2-dimensional distribution of relaxation times (DRT) contour plots of an IronPF∥Li cell (FIG. 19A), a Fe/Li₃PO₄∥Li cell (FIG. 19B), and a Fe/LiF∥Li Cell (FIG. 19C), derived from galvanostatic electrochemical impedance spectrometry (GEIS) results collected at 30° C.

FIGS. 20A and 20B are 2D DRT contour plots of an IronPF∥IronPF symmetric cell (FIG. 20A) and a Li∥Li symmetric cell (FIG. 20B), derived from the GEIS results.

FIG. 21 shows ultraviolet/visible absorption spectra of 1 M LiPF₆ in EC/DEC electrolyte, pristine, and the electrolyte after contacting FeF₃ for 12 h.

FIGS. 22A and 22B are electrochemical impedance spectroscopy (EIS) spectra collected at the anodic peak potential of Fe/LiF∥Li, Fe/Li₃PO₄∥Li, and IronPF∥Li cells (FIG. 22A); and the equivalent circuit used for fitting the Nyquist plots in FIG. 22A (FIG. 22B).

FIGS. 23A-23D are EIS analyses on the IronPF (FIG. 23A), Fe/LiF (FIG. 23B), and Fe/Li₃PO₄ (FIG. 23C) electrodes at various temperatures, and a graph of the functions that generate the activation energy barriers (FIG. 23D).

FIGS. 24A-24C show galvanostatic intermittent titration technique (GITT) measurements of the IronPF∥Li cell, Fe/LiF∥Li cell, and Fe/Li₃PO₄∥Li cell during charging (FIG. 24A), the corresponding ionic diffusion coefficients, D, of the above cells (FIG. 24B), and CV curves of the IronPF electrode at the scan rates of 1-5 mV s⁻¹ (FIG. 24C).

FIGS. 25A-25F show CV curves of the IronPF (FIG. 25A), Fe/LiF (FIG. 25B), and Fe/Li₃PO₄ (FIG. 25C) cathodes at the scan rates of 1-5 mV s⁻¹; and the b values for anodic and cathodic peaks of the IronPF (FIG. 25D) Fe/LiF (FIG. 25E), and Fe/Li₃PO₄ (FIG. 25F) cathodes from 1-5 mV s⁻¹.

FIGS. 26A and 26B are SEM images of a Cu₂S precursor (FIG. 26A) and a Li₂CO₃·1/2Cu₂S (CuLC) composite (FIG. 26B).

FIG. 27 show XRD patterns of commercial Li₂CO₃, commercial Cu₂S, and a CuLC composite.

FIGS. 28A-28E show the discharge-charge potential profiles of the CuLC cathode in the coin cell (FIG. 28A), cyclic voltammetry curve of the CuLC cathode at 0.1 mV/s in a coin cell with a 1 M LiPF₆ in EC (ethylene carbonate)/DEC (diethyl carbonate) (1:1 by volume) electrolyte (FIG. 28B), cycling performance of the CuLC cathode in the coin cell at 30 mA/g (FIG. 28C), and cycling performance of the CuLC cathode in coin cell at 100 mA/g (FIG. 28D), and cycling performance of the CuLC cathode in the coin cell at 100 mA/g over 175 cycles (FIG. 28E)

FIGS. 29A-29F show the cyclic voltammetry curve of a CuLC cathode at 0.1 mV/s in a coin cell with an electrolyte of 1.3 M LiTFSI in diglyme (FIG. 29A), discharge-charge potential profiles of the CuLC cathode in the coin cell (FIG. 29B), cycling performance of the CuLC cathode in the coin cell at 30 mA/g over 20 cycles (FIG. 29C), cycling performance of the CuLC cathode in the coin cell at 100 mA/g over 100 cycles (FIG. 29D), cycling performance of the CuLC cathode in the coin cell at 30 mA/g over 10 cycles (FIG. 29E), and cycling performance of the CuLC cathode in the coin cell at 200 mA/g over 240 cycles (FIG. 29F).

FIG. 30 shows ex situ XRD patterns of the pristine, fully charged, and fully discharged CuLC cathode.

FIGS. 31A and 31B are discharge charge potential profiles of the ball milled Cu₂S cathode in a coin cell (FIG. 31A) and discharge-charge potential profiles of the ball milled Li₂CO₃ cathode in a coin cell (FIG. 31B).

FIG. 32 shows FTIR spectra for the pristine, fully charged (FC), and fully discharged (FD) CuLC cathode during the first charge/discharge cycle.

FIGS. 33A-33F show initial charging capacities of the Li₂CO₃/Cu₂S composites evaluated across various molar ratios, specifically 2:1 (FIG. 33A), 1:1 (FIG. 33B), 1:2 (FIG. 33C), 1:4 (FIG. 33D), 1:8 (FIG. 33E), and 1:20 (FIG. 33F); the specific capacities were calculated based on the mass of Li₂CO₃.

FIGS. 34A and 34B show discharge-charge potential profiles of a Cu₂S·2Li₂SO₄ (CuLS) cathode in a coin cell (FIG. 34A), and cycling performance of the CuLS cathode in the coin cell (FIG. 34B).

FIGS. 35A-35D show the XRD patterns of a Li₂CO₃/Li₂SO₄·Cu₂S (CuLCS) composite (FIG. 35A), the cyclic voltammetry curves of the CuLCS cathode at 0.1 mV/s in a coin cell (FIG. 35B), discharge-charge potential profiles of the CuLCS cathode in the coin cell at 30 mA/g (FIG. 35C), and cycling performance of the CuLCS cathode in the coin cell at 100 mA/g (FIG. 35D).

FIGS. 36A and 36B show the charge discharge voltage profiles for 3 cycles of a full cell with a CuLCS cathode at 30 mA/g (FIG. 36A), and the initial cycling life of the cell over 6 cycles at 30 mA/g (FIG. 36B).

### DETAILED DESCRIPTION

This disclosure concerns embodiments of a composite cathode for metal batteries or metal ion batteries, where the metal is Li, Na, K, Mg, or Ca. The cathode comprises a composite of (i) a first component comprising one or more metal salts, wherein each metal salt is an alkali metal salt or an alkaline earth metal salt comprising M where M is Li, Na, K, Mg, Ca, or any combination thereof, (ii) a second component comprising a transition metal, a transition metal sulfide, a transition metal carbonate, a transition metal halide, or any combination thereof, and (iii) a third component comprising a carbon additive. In some aspects, the disclosed cathodes have high energy densities due to conversion reactions, have high coulombic efficiency, and/or exhibit stable cycling as evidenced by capacity retention. In some implementations, the disclosed composite cathodes are more sustainable than conventional cathodes, such as lithium nickel manganese cobalt oxide (NMC) cathodes. Metal ion batteries and/or metal batteries comprising the disclosed composite cathodes may be more sustainable and/or may exhibit a higher energy density than batteries with conventional cathodes.

### I. DEFINITIONS AND ABBREVIATIONS

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Definitions of common terms in chemistry may be found in Richard J. Lewis, Sr. (ed.), Hawley's Condensed Chemical Dictionary, published by John Wiley & Sons, Inc., 2016 (ISBN 978-1-118-13515-0).

In order to facilitate review of the various embodiments of the disclosure, the following explanations of specific terms are provided:

Additive: As used herein, the term “additive” refers to a component of an electrolyte that is present in an amount of greater than zero and less than or equal to 10 wt % or less than or equal to 20 mol % of the electrolyte.

Anode: An electrode through which electric charge flows into a polarized electrical device. From an electrochemical point of view, during battery discharge, positively-charged cations move away from or negatively-charged anions move toward the anode to balance the electrons leaving via external circuitry.

Capacity: The capacity of a battery is the amount of electrical charge a battery can deliver. The capacity is typically expressed in units of mAh, or Ah, and indicates the maximum constant current a battery can produce over a period of one hour. For example, a battery with a capacity of 100 mAh can deliver a current of 100 mA for one hour or a current of 5 mA for 20 hours.

Cathode: An electrode through which electric charge flows out of a polarized electrical device. From an electrochemical point of view, during battery discharge, positively charged cations invariably move toward the cathode and/or negatively charged anions move away from it to balance the electrons arriving from external circuitry.

Cell: As used herein, a cell refers to an electrochemical device used for generating a voltage or current from a chemical reaction, or the reverse in which a chemical reaction is induced by a current. Examples include voltaic cells, electrolytic cells, and fuel cells, among others. A battery includes one or more cells. The terms “cell” and “battery” are used interchangeably when referring to a battery containing only one cell.

Composite: A solid material composed of two or more constituent materials having different physical and/or chemical characteristics that, when combined, produce a material in which each substance retains its identity while contributing desirable properties to the whole. By “retains its identity” is meant that the individual materials remain separate and distinct within the composite structure. A composite, as a whole, is not a solid solution or a simple physical mixture of the constituent materials. In other words, each particle of the composite includes regions or domains of the two or more constituent materials.

Consists essentially of: With respect to the metal salt of the composite cathode, “consists essentially of” means that the composite cathode does not include other metal salts that materially affect the properties of the composite cathode alone or in a system including the composite cathode. Composite cathode properties include, but are not limited to, capacity (e.g., discharge capacity), specific capacity, capacity retention, specific energy, cathodic peaks in cyclic voltammetry, voltage plateau, and/or reversibility. For example, “consists essentially of” means that the composite cathode does not comprise another alkali metal salt or alkaline earth metal salt. With respect to the electrolyte, “consists essentially of” means that the electrolyte does not include other components that materially affect the properties of the electrolyte alone or in a system including the electrolyte. Electrolyte properties include conductivity, viscosity, flammability, reactivity, and/or electrode compatibility. For example, “consists essentially of” means that the electrolyte does not include any electrochemically active component (i.e., a component (an element, an ion, or a salt) that is capable of forming redox pairs having different oxidation and reduction states, e.g., ionic species with differing oxidation states or a metal cation and its corresponding neutral metal atom), other than the recited salts, in an amount sufficient to affect performance of the electrolyte, additional solvents other than the flame retardant compound and any recited cosolvent, or other additives in a significant amount (e.g., >1 wt %).

CuLC: Cu₂S/Li₂CO₃

CuLCS: Cu₂S/Li₂CO₃/Li₂SO₄

CuLS: Cu₂S/Li₂SO₄

Current collector: A battery component that conducts the flow of electrons between an electrode and a battery terminal. The current collector also may provide mechanical support for the electrode's active material. For example, a metal mesh current collector may provide mechanical support for a composite cathode as disclosed herein.

Electrolyte: A substance containing free ions that behaves as an electrically conductive medium. Electrolytes generally comprise ions in a solution, but molten electrolytes and solid electrolytes also are known.

IronPF: Fe/Li₃PO₄/LiF

Metal salt composite cathode: As used herein, a metal salt composite cathode comprises solid-state metal salts mixed with an anion-hosting active mass of the cathode. The active mass serves as the electron source and anion host, and the metal salt is the source of ion charge carriers. During charging, the metal salt dissociates and metal ions migrate to the anode via the electrolyte, while counter anions transport locally to form ionic bonds with the active mass.

Solid solution: A homogeneous solid mixture having a minor component uniformly distributed within a major component. As used herein, the term solid solution refers to a uniform solid mixture of two or more metal salts, wherein the solid solution is one component of a composite.

Specific capacity: A term that refers to capacity per unit of mass. Specific capacity may be expressed in units of mAh/g.

### II. METAL SALT COMPOSITE CATHODES

A metal salt composite cathode comprises a composite of (i) a first component comprising one or more metal salts, wherein each metal salt is an alkali metal salt or alkaline earth metal salt comprising M where M is Li, Na, K, Mg, Ca, or any combination thereof, (ii) a second component comprising a transition metal, a transition metal sulfide, a transition metal carbonate, a transition metal halide, or any combination thereof, and (iii) a carbon additive. In some aspects, the cathode comprises a composite of (i) a lithium salt, a sodium salt, a potassium salt, a magnesium salt, a calcium salt, or any combination thereof, (ii) Cu₂S, Cu₂O, Cu, Fe, MnCO₃, MnF₂, Mn, Ni, Co, V, Cr, FeS, FeS₂, or any combination thereof, and (iii) a carbon additive. In any of the foregoing or following aspects, the carbon additive may comprise carbon black, graphite, or a combination thereof. In certain aspects, the metal salt is an alkali metal salt, such as a lithium salt, a sodium salt, a potassium salt, or any combination thereof. In any of the foregoing or following aspects, suitable anions for the metal salts include, but are not limited to, BO₃³⁻, CO₃²⁻, PO₄³⁻, OH⁻, HCOO⁻, CH₃COO⁻, F⁻, Cl⁻, Br⁻, HCO₃⁻, SO₄²⁻, SO₃²⁻, HSO₄⁻, HPO₄²⁻, H₂PO₄⁻, NO₃⁻, ClO₃⁻, ClO₄⁻, or any combination thereof.

In some implementations, the cathode comprises a composite of (i) a lithium salt, a sodium salt, a potassium salt, or any combination thereof, (ii) Cu₂S, Cu₂O, Cu, Fe, MnCO₃, MnF₂, Mn, Ni, Co, V, Cr, FeS, FeS₂, or any combination thereof, and (iii) carbon black or graphite. In certain implementations, the salt is a lithium salt, a sodium salt, or a combination thereof. In some examples, the salt is a lithium salt. In other implementations, the cathode comprises a composite of (i) a calcium salt, a magnesium salt, or a combination thereof, (ii) Cu₂S, Cu₂O, Cu, Fe, MnCO₃, MnF₂, Mn, Ni, Co, V, Cr, FeS, FeS₂, or any combination thereof, and (iii) carbon black or graphite. In any of the foregoing or following aspects, the salts in the composite may be in an amorphous state.

Each metal salt may be represented by MₓA_{y}, where M represents Li, Na, K, Mg, or Ca, A represents an anion, and x and y are integers representing the stoichiometric ratio of M and A. For example, if M is Li and A is phosphate, then x is 3, y is 1, and the metal salt is Li₃PO₄. In some aspects, the metal salt is an anhydrous alkali metal salt or an anhydrous alkaline earth metal salt. In some implementations, the first component of the composite cathode comprises a single metal salt. In other implementations, the first component of the composite cathode comprises a plurality of metal salts, such as two, three, four, or more metal salts. In certain aspects, the first component comprises two or more metal salts in the form of a solid solution. In certain implementations, the composite cathode has a ternary composition comprising two metal salts and the second component. In some examples, when the first component comprises a plurality of metal salts, the salts have a common metal M and the anions differ, e.g., LiF and Li₂CO₃. In some aspects, the metal salt of the cathode is insoluble (less than 0.1 g/L) or only slightly soluble (0.1 g/L to 10 g/L) in the electrolyte of a battery including the cathode. Suitable anions A include, but are not limited to, BO₃³⁻, CO₃²⁻, PO₄³⁻, OH⁻, HCOO⁻, CH₃COO⁻, F⁻, Cl⁻, Br⁻, HCO₃⁻, SO₄²⁻, SO₃²⁻, HSO₄⁻, HPO₄²⁻, H₂PO₄⁻, NO₃⁻, ClO₃⁻, ClO₄⁻, or any combination thereof.

Accordingly, in any of the foregoing or following aspects, the metal salt may comprise, consist essentially of, or consist of Mₓ(BO₃)_{y}, Mₓ(CO₃)_{y}, Mₓ(PO₄)_{y}, Mₓ(OH)_{y}, (HCOO)_{y}Mₓ, (CH₃COO)_{y}Mₓ, MₓF_{y}, MₓCl_{y}, MₓBr_{y}, Mₓ(HCO₃)_{y}, Mₓ(SO₄)_{y}, Mₓ(SO₃)_{y}, Mₓ(HSO₄)_{y}, Mₓ(HPO₄)_{y}, Mₓ(H₂PO₄)_{y}, Mₓ(NO₃)_{y}, Mₓ(ClO₃)_{y}, Mₓ(ClO₄)_{y}, or any combination thereof. In some aspects, the anion A is CO₃²⁻, PO₄³⁻, OH⁻, HCOO⁻, CH₃COO⁻, or any combination thereof. In one aspect, M is Li. In another aspect, M is Na. In yet another aspect, M is K. In still another aspect, M is Mg. In yet another aspect, M is Ca. In some implementations, M is Li, Na, or K. In certain implementations, M is Li or Na.

In some aspects, M is Li and the lithium salt comprises Li₃BO₃, Li₂CO₃, Li₃PO₄, LiOH, HCOOLi, CH₃COOLi, LiF, LiCl, LiBr, LiHCO₃, Li₂SO₄, Li₂SO₃, LiHSO₄, Li₂HPO₄, LiH₂PO₄, LiNO₃, LiClO₃, LiClO₄, or any combination thereof. In certain implementations, the lithium salt comprises Li₂CO₃, LiF, Li₃PO₄, LiOH, HCOOLi, CH₃COOLi, or any combination thereof.

In some aspects, M is Na and the sodium salt comprises Na₃BO₃, Na₂CO₃, Na₃PO₄, NaOH, HCOONa, CH₃COONa, NaF, NaCl, NaBr, NaHCO₃, Na₂SO₄, Na₂SO₃, NaHSO₄, Na₂HPO₄, NaH₂PO₄, NaNO₃, NaClO₃, NaClO₄, or any combination thereof. In certain implementations, the sodium salt comprises Na₂CO₃, NaF, Na₃PO₄, NaOH, HCOONa, CH₃COONa, or any combination thereof.

In some aspects, M is K and the potassium salt comprises K₃BO₃, K₂CO₃, K₃PO₄, KOH, HCOOK, CH₃COOK, KF, KCl, KBr, KHCO₃, K₂SO₄, K₂SO₃, KHSO₄, K₂HPO₄, KH₂PO₄, KNO₃, KClO₃, KClO₄, or any combination thereof. In certain implementations, the potassium salt comprises K₂CO₃, KF, K₃PO₄, KOH, HCOOK, CH₃COOK, or any combination thereof.

In some aspects, M is Mg and the magnesium salt comprises Mg₃(BO₃)₂, MgCO₃, Mg₃(PO₄)₂, Mg(OH)₂, (HCOO)₂Mg, (CH₃COO)₂Mg, MgF₂, MgCl₂, MgBr₂, Mg(HCO₃)₂, MgSO₄, MgSO₃, Mg(HSO₄)₂, MgHPO₄, Mg(H₂PO₄)₂, Mg(NO₃)₂, Mg(ClO₃)₂, Mg(ClO₄)₂, or any combination thereof.

In some aspects, M is Ca and the calcium salt comprises Ca₃(BO₃)₂, CaCO₃, Ca₃(PO₄)₂, Ca(OH)₂, (HCOO)₂Ca, (CH₃COO)₂Ca, CaF₂, CaCl₂, CaBr₂, Ca(HCO₃)₂, CaSO₄, CaSO₃, Ca(HSO₄)₂, CaHPO₄, Ca(H₂PO₄)₂, Ca(NO₃)₂, Ca(ClO₃)₂, Ca(ClO₄)₂, or any combination thereof.

In any of the foregoing or following aspects, M may be Li, Na, K, or any combination thereof, and the composite may have an M:Cu₂S molar ratio of 2 to 8; an M:Cu₂O molar ratio of 2 to 8; an M:Cu molar ratio of 1 to 4; an M:Fe molar ratio of 1 to 6; an M:MnCO₃ molar ratio of 1 to 4; an M:MnF₂ molar ratio of 1 to 4; an M:Mn molar ratio of 2 to 8; an M:Ni molar ratio of 2 to 8; an M:Co molar ratio of 1 to 6; an M:V molar ratio of 2 to 10; an M:Cr molar ratio of 1 to 6; an M:FeS molar ratio of 1 to 6; or an M:FeS₂ molar ratio of 1 to 6. In certain aspects, M is Li, Na, K, or any combination thereof, and the composite has an M:Cu₂S molar ratio of 2 to 4; an M:Cu₂O molar ratio of 2 to 4; an M:Cu molar ratio of 1 to 2; an M:Fe molar ratio of 1 to 3; an M:MnCO₃ molar ratio of 1 to 2; an M:MnF₂ molar ratio of 1 to 2; an M:Mn molar ratio of 2 to 4; an M:Ni molar ratio of 2 to 4; an M:Co molar ratio of 1 to 3; an M:V molar ratio of 2 to 5; an M:Cr molar ratio of 1 to 3; an M:FeS molar ratio of 1 to 3; or an M:FeS₂ molar ratio of 1 to 3. In some examples, M is Li, Na, K, or any combination thereof, and the composite has an M:Cu₂S stoichiometric ratio of 4; an M:Cu₂O molar ratio of 4; an M:Cu stoichiometric ratio of 2; an M:Fe stoichiometric ratio of 3; an M:MnCO₃ stoichiometric ratio of 2; an M:MnF₂ molar ratio of 2; an M:Mn stoichiometric ratio of 4; an M:Ni stoichiometric ratio of 4; an M:Co stoichiometric ratio of 3; an M:V stoichiometric ratio of 5; an M:Cr stoichiometric ratio of 3; an M:FeS stoichiometric ratio of 3; or an M:FeS₂ stoichiometric ratio of 3. In any of the foregoing aspects, M may be Li, Na, K or any combination thereof. In some aspects, M is Li, Na, or a combination thereof. In one aspect, M is Li. In an independent aspect, M is Na. In another independent aspect, M is K. In yet another independent aspect, M is a combination of Li and Na, a combination of Li and K, or a combination of Na and K.

In any of the foregoing or following aspects, M may be Mg, Ca, or a combination thereof, and the composite may have an M:Cu₂S molar ratio of 1 to 4; an M:Cu molar ratio of 0.5 to 2; an M:Fe molar ratio of 0.5 to 3; an M:MnCO₃ molar ratio of 0.5 to 2; an M:Mn molar ratio of 1 to 4; an M:Ni molar ratio of 1 to 4; an M:Co molar ratio of 0.5 to 3; an M:V molar ratio of 1 to 5; an M:Cr molar ratio of 0.5 to 3; an M:FeS molar ratio of 0.5 to 3; or an M:FeS₂ molar ratio of 0.5 to 3. In certain aspects, M is Mg, Ca, or a combination thereof, and the composite has an M:Cu₂S molar ratio of 1 to 2; an M:Cu molar ratio of 0.5 to 1; an M:Fe molar ratio of 0.5 to 1.5; an M:MnCO₃ molar ratio of 0.5 to 1; an M:Mn molar ratio of 1 to 2; an M:Ni molar ratio of 1 to 2; an M:Co molar ratio of 0.5 to 1.5; an M:V molar ratio of 1 to 2.5; an M:Cr molar ratio of 0.5 to 1.5; an M:FeS molar ratio of 0.5 to 1.5; or an M:FeS₂ molar ratio of 0.5 to 1.5. In some examples, M is Mg, Ca, or a combination thereof, and the composite has an M:Cu₂S stoichiometric ratio of 2; an M:Cu stoichiometric ratio of 1; an M:Fe stoichiometric ratio of 1.5; an M:MnCO₃ stoichiometric ratio of 1; an M:Mn stoichiometric ratio of 2; an M:Ni stoichiometric ratio of 2; an M:Co stoichiometric ratio of 1.5; an M:V stoichiometric ratio of 2.5; an M:Cr stoichiometric ratio of 1.5; an M:FeS stoichiometric ratio of 1.5; or an M:FeS₂ stoichiometric ratio of 1.5. In one aspect, M is Mg. In an independent aspect, M is Ca. In still another independent aspect, M is a combination of Mg and Ca.

Advantageously, the composite cathodes undergo a reversible multi-electron redox conversion reaction. In some aspects, the reaction is Cu₂S (Cu⁺↔Cu²⁺, S²⁻↔S), Cu₂O (Cu⁺↔Cu²⁺, O²⁻↔O⁻), Cu (Cu↔Cu²⁺), Fe (Fe↔Fe³⁺), MnCO₃ (Mn²⁺↔Mn⁴⁺), MnF₂ (Mn²⁺↔Mn⁴⁺), Mn (Mn↔Mn⁴⁺), Ni (Ni↔Ni⁴⁺), Co (Co↔Co³⁺), V (V↔V⁵⁺), Cr (Cr↔Cr³⁺), FeS (Fe²⁺↔Fe³⁺, S²⁻↔S), or FeS₂ (Fe²⁺↔Fe³⁺, S¹⁻↔S), with A anions compensating the local charge-neutrality, and the redox conversion reaction of polyanions (CO₃²⁻↔CO₃⁻, SO₄²⁻↔SO₄⁻).

The redox conversion reaction is a solid-state reaction, and the first component of the cathode includes a solid solution of anions (provided by the metal salt or salts) as charge carriers facilitating the reversible conversion. In some aspects, the metal salt(s) are present in an amorphous state, which may promote anion transport more effectively than crystalline counterparts. A simplified generalized reaction is depicted below where “ES” represents an electron source (e.g., a transition metal, a transition metal sulfide, a transition metal carbonate, or any combination thereof), M, A, x, and y are as previously defined, and z is an integer representing the stoichiometric ratio of ES to A_{y}. During charging, the MₓA_{y} salt dissociates and M⁺ or M²⁺ cations migrate to the anode via the electrolyte, while the counter anions transport locally within the cathode to form ionic bonds with the electron source. In a discharge process, the lithium ions react with the ES salts to re-form the MₓA_{y} salt(s) and the ES. In the exemplary reaction below, M is Li, Na, or K.

zES(s)+MₓA_{y}(s)↔(ES)_{z}A_{y}+xM^{y+}(sol)+x·ye⁻

As shown in the exemplary reaction above, the metal salt MₓA_{y} in the cathode dissociates into A anions and M cations as the battery charges. The M cations migrate to the anode via the electrolyte. During discharge, M cations migrate to the cathode and regenerate MₓA_{y}. At the device level, it is the M ions that migrate between the cathode and anode. As a result, the cathode can couple with any anode useful in metal or metal ion batteries, such as alkali metal batteries, alkali metal ion batteries, alkaline earth batteries, or alkaline earth metal ion batteries. At the cathode level, the conversion reactions utilize anions as the charge carrier. In certain aspects, Cu₂S is a promising anion-hosting cathode material because Cu₂S, as a natural mineral, is a conductor of both electrons and copper ions. In other aspects, Fe is a promising anion-hosting cathode material.

In some aspects, the second component comprises Cu₂S, which may act as a catalyst rather than an electron source. Without wishing to be bound by a particular theory of operation, the mechanism may be as shown in the following exemplary, non-limiting reactions. Interestingly, covalently bound anions may be oxidized as the battery charges.

$$\\ {Li}_{2} {CO}_{3} {⟶}^{{Cu}_{2} S} {{Li}^{}}^{+} + {LiCO}_{3} + {e}^{-} ,$$

$$\\ {Li}_{4} {CO}_{3} {SO}_{4} {⟶}^{{Cu}_{2} S} 2 {{Li}^{}}^{+} + {Li}_{2} {CO}_{3} {SO}_{4} + 2 {e}^{-} ,$$

$$\\ {Li}_{4} {CO}_{3} {SO}_{4} {⟶}^{{Cu}_{2} S} 3 {{Li}^{}}^{+} + {LiCO}_{3} {SO}_{4} + 3 {e}^{-}$$

In any of the foregoing or following aspects, the composite cathode may comprise Mₓ(PO₄)_{y} and Fe, MₓF_{y} and Fe, Mₓ(CO₃)_{y} and Cu₂S, Mₓ(SO₄)_{y} and Cu₂S, Mₓ(PO₄)_{y} and Cu₂S, Mₓ(OH)_{y} and Cu₂S, (HCOO)_{y}Mₓ and Cu₂S, (CH₃COO)_{y}Mₓ and Cu₂S, Mₓ(CO₃)_{y} and Cu, Mₓ(PO₄)_{y} and Cu, Mₓ(CO₃) and MnCO₃, or any combination thereof, where x and y are as previously defined. In some aspects, M is Li, Na, or K, and the composite cathode comprises 3M₃PO₄·3MF·4Fe, 6M₃PO₄·3MF·7Fe, 3M₃PO₄·6MF·5Fe, M₂CO₃·0.5Cu₂S, M₂SO₄·0.5Cu₂S, M₃PO₄·0.75Cu₂S, MOH·0.25Cu₂S, HCOOM·0.25Cu₂S, CH₃COOM·0.25Cu₂S, M₂CO₃·Cu, M₃PO₄·1.5Cu, M₃PO₄·Fe, 3MF·Fe, M₂CO₃·MnCO₃, or any combination thereof. In certain implementations, a ternary composition of Fe, M₃PO₄, and MF combines advantages of the high discharge potential conferred by Fe/M₃PO₄ with the high iron utilization of Fe/MF. In another implementation, the cathode comprises a ternary composition of M₂CO₃/M₂SO₄·Cu₂S. In any of the foregoing or following aspects, M may be Li or Na. In certain aspects, M is Li.

The composite cathode further comprises a carbon additive. In some aspects, the carbon additive is a conductive carbon, such as carbon black, carbon fibers, graphite, graphene, or any combination thereof. In some implementations, the conductive carbon comprises a carbon black, such as KetjenBlack® carbon black (Akzo Nobel Chemicals B.V.) or acetylene black.

In any of the foregoing or following aspects, the composite cathode may further comprise a binder. In some implementations, the binder comprises polytetrafluoroethylene, polyvinyl alcohol, polyvinyl chloride, polyvinyl fluoride, ethylene oxide polymers, polyvinylpyrrolidone, polyurethane, polyvinylidene fluoride, polyethylene, polypropylene, styrene-butadiene rubber, epoxy resin, nylon, or any combination thereof. In certain examples, the binder comprises polytetrafluoroethylene.

In any of the foregoing or following aspects, the cathode may comprise 2 wt % to 15 wt % binder and/or 1 wt % to 15 wt % conductive carbon. Thus, the cathode may comprise 70 wt % to 97 wt % of the composite, 2 wt % to 15 wt % binder, and 1 wt % to 15 wt % conductive carbon. In some aspects, the cathode comprises 70 wt % to 90 wt % of the composite, 5 wt % to 15 wt % binder, and 5 wt % to 15 wt % conductive carbon. In certain implementations, the cathode comprises 80 wt % of the composite, 10 wt % binder, and 10 wt % conductive carbon.

In any of the foregoing or following aspects, the composite cathode may be disposed on a cathode current collector. The current collector may reduce the polarization of the electrode receiving and outputting electrons. The current collector may be any suitable conductive material that is compatible with the cathode and the electrolyte. Exemplary current collectors include, but are not limited to, carbon paper, carbon felt, glassy carbon, stainless steel foil/foam/mesh, nickel foam/mesh, aluminum foil/mesh, copper foil/mesh, and titanium foil/mesh. In some aspects, the current collector comprises titanium, such as titanium mesh. In some implementations, the areal loading of the cathode material on the current collector is 10 mg/cm² to 20 mg/cm², such as 12 mg/cm² to 15 mg/cm².

In some examples, composite electrodes comprising Li₂CO₃·0.5Cu₂S, Li₂SO₄·0.5Cu₂S, Li₂CO₃/Li₂SO₄·Cu₂S, Li₃PO₄·0.75Cu₂S, LiOH·0.25Cu₂S, HCOOLi·0.25Cu₂S, CH₃COOLi·0.25Cu₂S, Li₂CO₃·Cu, Li₃PO₄·1.5Cu, Li₃PO₄·Fe and Li₂CO₃·MnCO₃ provided a reversible capacity of 165, 105, 245, 50, 58, 130, 110, 83, 110, 70, and 103 mAh/g at the average potential of 2.8, 3.1, 3.0, 2.7, 3.5, 3.2, 2.8, 2.8, 3.0, 3.0, and 3.0 V versus Li⁺/Li, respectively. In certain examples, a composite electrode comprising Li₃PO₄/LiF·Fe (3:3:4 molar ratio) delivered a reversible capacity up to 368 mAh/g at 60° C. and a specific energy exceeding 940 Wh/kg. In other examples, a composite electrode comprising Li₂CO₃/Li₂SO₄/Cu₂S (1:1:1 molar ratio), which alternatively may be represented as Li₄CO₃SO₄/Cu₂S, delivered a reversible capacity up to 245 mAh/g and a specific energy of 735 Wh/kg.

### III. METHOD OF MAKING METAL SALT COMPOSITE CATHODES

A method of making a metal salt composite cathode as disclosed herein includes combining (i) a first component comprising one or more anhydrous metal salts, wherein each anhydrous metal salt is an alkali metal salt or an alkaline earth metal salt comprising M where M is Li, Na, K, Mg, Ca, or any combination thereof, (ii) a second component comprising a transition metal, a transition metal sulfide, a transition metal carbonate, a transition metal halide, or any combination thereof, and (iii) a third component comprising a carbon additive, or any combination thereof to form a mixture, and milling the mixture to form a composite. In some aspects, the second component comprises Cu₂S, Cu₂O, Cu, Fe, MnCO₃, MnF₂, Mn, Ni, Co, V, Cr, FeS, FeS₂, or any combination thereof. In any of the foregoing or following aspects, suitable anions for the anhydrous metal salts include, but are not limited to, BO₃³⁻, CO₃²⁻, PO₄³⁻, OH⁻, HCOO⁻, CH₃COO⁻, F⁻, Cl⁻, Br⁻, HCO₃⁻, SO₄²⁻, SO₃²⁻, HSO₄, HPO₄²⁻, H₂PO₄⁻, NO₃⁻, ClO₃⁻, ClO₄⁻, or any combination thereof.

In some aspects, the anhydrous metal salt is a Li salt, a Na salt, a K salt, or any combination thereof, and is combined with the second component at an M:Cu₂S molar ratio of 2 to 8; an M:Cu₂O molar ratio of 2 to 8; an M:Cu molar ratio of 1 to 4; an M:Fe molar ratio of 1 to 6; an M:MnCO₃ molar ratio of 1 to 4; an M:MnF₂ molar ratio of 1 to 4; an M:Mn molar ratio of 2 to 8; an M:Ni molar ratio of 2 to 8; an M:Co molar ratio of 1 to 6; an M:V molar ratio of 2 to 10; an M:Cr molar ratio of 1 to 6; an M:FeS molar ratio of 1 to 6; or an M:FeS₂ molar ratio of 1 to 6. In certain implementations, the anhydrous metal salt is a Li, a Na, a K salt, or any combination thereof, and is combined with the second component at an M:Cu₂S molar ratio of 2 to 4; an M:Cu₂O molar ratio of 2 to 4; an M:Cu molar ratio of 1 to 2; an M:Fe molar ratio of 1 to 3; an M:MnCO₃ molar ratio of 1 to 2; an M:MnF₂ molar ratio of 1 to 2; an M:Mn molar ratio of 2 to 4; an M:Ni molar ratio of 2 to 4; an M:Co molar ratio of 1 to 3; an M:V molar ratio of 2 to 5; an M:Cr molar ratio of 1 to 3; an M:FeS molar ratio of 1 to 3; or an M:FeS₂ molar ratio of 1 to 3. In some examples, the anhydrous metal salt is a Li salt, a Na salt, a K salt, or any combination thereof, and is combined with the second component at an M:Cu₂S stoichiometric ratio of 4; an M:Cu₂O molar ratio of 4; an M:Cu stoichiometric ratio of 2; an M:Fe stoichiometric ratio of 3; an M:MnCO₃ stoichiometric ratio of 2; an M:MnF₂ molar ratio of 2; an M:Mn stoichiometric ratio of 4; an M:Ni stoichiometric ratio of 4; an M:Co stoichiometric ratio of 3; an M:V stoichiometric ratio of 5; an M:Cr stoichiometric ratio of 3; an M:FeS stoichiometric ratio of 3; or an M:FeS₂ stoichiometric ratio of 3. In some aspects, the anhydrous metal salt is a Mg salt, a Ca salt, or a combination thereof, and is combined with the second component at an M:Cu₂S molar ratio of 1 to 4; an M:Cu₂O molar ratio of 1 to 4; an M:Cu molar ratio of 0.5 to 2; an M:Fe molar ratio of 0.5 to 3; an M:MnCO₃ molar ratio of 0.5 to 2; an M:MnF₂ molar ratio of 0.5 to 2; an M:Mn molar ratio of 1 to 4; an M:Ni molar ratio of 1 to 4; an M:Co molar ratio of 0.5 to 3; an M:V molar ratio of 1 to 5; an M:Cr molar ratio of 0.5 to 3; an M:FeS molar ratio of 0.5 to 3; or an M:FeS₂ molar ratio of 0.5 to 3. In certain implementations, the anhydrous metal salt is a Mg salt, a Ca salt, or a combination thereof, and is combined with the second component at an M:Cu₂S molar ratio of 1 to 2; an M:Cu₂O molar ratio of 1 to 2; an M:Cu molar ratio of 0.5 to 1; an M:Fe molar ratio of 0.5 to 1.5; an M:MnCO₃ molar ratio of 0.5 to 1; an M:MnF₂ molar ratio of 0.5 to 1; an M:Mn molar ratio of 1 to 2; an M:Ni molar ratio of 1 to 2; an M:Co molar ratio of 0.5 to 1.5; an M:V molar ratio of 1 to 2.5; an M:Cr molar ratio of 0.5 to 1.5; an M:FeS molar ratio of 0.5 to 1.5; or an M:FeS₂ molar ratio of 0.5 to 1.5.

In some aspects, M is Li, Na, K, or any combination thereof. In certain aspects, M is Li, Na, or a combination thereof. In one aspect, M is Li. In an independent aspect, M is Na. In another independent aspect, M is K. In yet another independent aspect, M is a combination of Li and Na, a combination of Li and K, or a combination of Na and K. In other aspects, M is Mg, Ca, or a combination thereof. In one aspect, M is Mg. In an independent aspect, M is Ca. In still another independent aspect, M is a combination of Mg and Ca.

In any of the foregoing or following aspects, milling may comprise ball milling in an inert atmosphere, such as an argon or nitrogen atmosphere. In some implementations, balling milling is performed for a total milling time of 1 hour to 50 hours. The milling process may include periods of milling (such as 15 minutes to 45 minutes of milling) alternating with rest periods (such as 5-15 minutes of rest). In some examples, ball milling was performed for 30 minute intervals at 400 r.p.m., followed by rest periods of 10 minutes between milling intervals.

In some aspects, the method further comprises combining the composite with a binder, conductive carbon, or a binder and conductive carbon to form a subsequent mixture. Combining may be performed by any suitable process. For example, the composite, binder, and conductive carbon may be ground together to form a mixture. In some implementations, the binder comprises polytetrafluoroethylene, polyvinyl alcohol, polyvinyl chloride, polyvinyl fluoride, ethylene oxide polymers, polyvinylpyrrolidone, polyurethane, polyvinylidene fluoride, polyethylene, polypropylene, styrene-butadiene rubber, epoxy resin, nylon, or any combination thereof. In some aspects, the conductive carbon comprises carbon black, carbon fibers, graphite, graphene, or any combination thereof. In some examples, the binder comprises polytetrafluoroethylene and/or the conductive carbon is carbon black, such as KetjenBlack® carbon black or acetylene black. In some aspects, the composite, binder, and carbon are combined at a weight ratio of 70 wt % to 97 wt % composite, 2 wt % to 15 wt % binder, and 1 wt % to 15 wt % conductive carbon. In some implementations, the composite, binder, and carbon are combined at a weight ratio of 70 wt % to 90 wt % composite, 4 wt % to 15 wt % binder, and 4 wt % to 15 wt % carbon. In certain aspects, the cathode comprises 80 wt % of the composite, 10 wt % binder, and 10 wt % conductive carbon.

In any of the foregoing or following aspects, the cathode material (composite or mixture of composite, binder and/or conductive carbon) may be applied to a current collector. In some aspects, the current collector comprises titanium foil or mesh, carbon paper, carbon felt, glassy carbon, stainless steel foil, foam, or mesh, nickel foam or mesh, aluminum foil or mesh, or copper foil or mesh. In certain examples, the cathode material is compressed onto a titanium mesh current collector. In some implementations, the areal loading of the cathode material on the current collector is 10 mg/cm² to 20 mg/cm², such as 12 mg/cm² to 15 mg/cm².

### IV. METAL AND METAL ION BATTERIES

A battery includes a composite cathode as disclosed herein, an anode, and an electrolyte. The battery may further include a separator disposed between the cathode and the anode. The battery may be an alkali metal battery or an alkali metal ion battery, such as a lithium metal battery, a lithium ion battery, a sodium metal battery, a sodium ion battery, a potassium metal battery, or a potassium ion battery. Alternatively, the battery may be an alkaline earth metal battery or an alkaline earth metal ion battery, such as a magnesium metal battery, a magnesium ion battery, a calcium metal battery, or a calcium ion battery.

The anode may be any anode suitable for a lithium metal, lithium ion, sodium metal, sodium ion, potassium metal, potassium ion, magnesium metal, magnesium ion, calcium metal, or calcium ion battery. In some aspects, the anode comprises lithium metal, sodium metal, potassium metal, magnesium metal, calcium metal, graphite, silicon, SiO, a Si/C composite, Li₄Ti₅O₁₂, a transition metal oxide, a transition metal sulfide, tin, or antimony. In some implementations, the battery is a lithium metal battery, a lithium ion battery, a sodium metal battery, or a sodium ion battery. In some examples, the battery is a lithium metal battery and the anode comprises lithium metal. In certain examples, the battery is a lithium ion battery and the anode comprises graphite, silicon, SiO, a Si/C composite, Li₄Ti₅O₁₂, a transition metal oxide, a transition metal sulfide, tin, or antimony.

The electrolyte may be any electrolyte suitable for an alkali metal, alkaline earth metal, alkali metal ion, or alkaline earth metal ion battery and compatible with the cathode and anode materials. In some aspects, the electrolyte comprises a metal salt, such as an alkali metal salt or an alkaline earth metal salt (e.g., a lithium salt, a sodium salt, a potassium salt, a magnesium salt, or a calcium salt), and a solvent. The metal salt of the electrolyte is dissolved in the solvent. In some aspects, the metal salt of the electrolyte is different than the metal salt of the cathode. While the metal may be the same, the anion is different. For example, if the cathode comprises LiNO₃, then the electrolyte does not comprise LiNO₃.

Exemplary lithium salts for the electrolyte include, but are not limited to, LiPF₆, lithium bis(trifluoromethanesulfonyl)imide (LiTFSI), lithium bis(fluorosulfonyl)imide (LiFSI), lithium bis(oxalato)borate (LiB(C₂O₄)₂, LiBOB), lithium difluoro(oxalato)borate (LiBF₂(C₂O₄), LiDFOB), LiCF₃SO₃, LiAsF₆, LiBF₄, LiSCN, lithium bis(pentafluoroethanesulfonyl)imide (LiN(SO₂CF₂CF₃)₂, LiBETI), lithium (fluorosulfonyl trifluoromethanesulfonyl)imide (LiN(SO₂F)(SO₂CF₃), LiFTFSI), lithium (fluorosulfonyl pentafluoroethanesulfonyl)imide (LiN(SO₂F)N(SO₂CF₂CF₃), LiFBETI), lithium cyclo(tetrafluoroethylenedisulfonyl)imide (LIN(SO₂CF₂CF₂SO₂), LiCTFSI), lithium (trifluoromethanesulfonyl)(n-nonafluorobutanesulfonyl)imide (LiN(SO₂CF₃)(SO₂-n-C₄F₉), LiTNFSI), or any combination thereof. In some aspects, the lithium salt is LiPF6, LiTFSI, or a combination thereof.

Exemplary sodium salts for the electrolyte include, but are not limited to, NaPF₆, sodium bis(trifluoromethanesulfonyl)imide (NaTFSI), sodium bis(fluorosulfonyl)imide (NaFSI), sodium bis(oxalato)borate (NaB(C₂O₄)₂, NaBOB), sodium difluoro(oxalato)borate (NaBF₂(C₂O₄), NaDFOB), NaCF₃SO₃, NaAsF₆, NaBF₄, NaSCN, sodium bis(pentafluoroethanesulfonyl)imide (NaN(SO₂CF₂CF₃)₂, NaBETI), sodium (fluorosulfonyl trifluoromethanesulfonyl)imide (NaN(SO₂F)(SO₂CF₃), NaFTFSI), sodium (fluorosulfonyl pentafluoroethanesulfonyl)imide (NaN(SO₂F)N(SO₂CF₂CF₃), NaFBETI), sodium cyclo(tetrafluoroethylenedisulfonyl)imide (NaN(SO₂CF₂CF₂SO₂), NaCTFSI), sodium (trifluoromethanesulfonyl)(n-nonafluorobutanesulfonyl)imide (NaN(SO₂CF₃)(SO₂-n-C₄F₉), NaTNFSI), or any combination thereof. In some aspects, the sodium salt is NaPF₆, NaTFSI, or a combination thereof.

Exemplary potassium salts for the electrolyte include, but are not limited to, KPF₆, potassium bis(trifluoromethanesulfonyl)imide (KTFSI), potassium bis(fluorosulfonyl)imide (KFSI), potassium bis(oxalato)borate (KB(C₂O₄)₂, KBOB), potassium difluoro(oxalato)borate (KBF₂(C₂O₄), KDFOB), KCF₃SO₃, KAsF₆, KBF₄, KSCN, potassium bis(pentafluoroethanesulfonyl)imide (KN(SO₂CF₂CF₃)₂, KBETI), potassium (fluorosulfonyl trifluoromethanesulfonyl)imide (KN(SO₂F)(SO₂CF₃), KFTFSI), potassium (fluorosulfonyl pentafluoroethanesulfonyl)imide (KN(SO₂F)N(SO₂CF₂CF₃), KFBETI), potassium cyclo(tetrafluoroethylenedisulfonyl)imide (KN(SO₂CF₂CF₂SO₂), KCTFSI), potassium (trifluoromethanesulfonyl)(n-nonafluorobutanesulfonyl)imide (KN(SO₂CF₃)(SO₂-n-C₄F₉), KTNFSI), or any combination thereof. In some aspects, the potassium salt is KPF₆, KTFSI, or a combination thereof.

Exemplary magnesium salts for the electrolyte include, but are not limited to, Mg(PF₆)₂, magnesium bis(trifluoromethanesulfonyl)imide (MgTFSI), magnesium bis(fluorosulfonyl)imide (MgFSI), magnesium bis(oxalato)borate (Mg[B(C₂O₄)₂]₂, MgBOB), magnesium difluoro(oxalato)borate (Mg[BF₂(C₂O₄)]₂, MgDFOB), Mg(CF₃SO₃)₂, Mg(AsF₆)₂, Mg(BF₄)₂, Mg(SCN)₂, magnesium bis(pentafluoroethanesulfonyl)imide (Mg[N(SO₂CF₂CF₃)₂]₂, MgBETI), magnesium (fluorosulfonyl trifluoromethanesulfonyl)imide (Mg[N(SO₂F)(SO₂CF₃)]₂, MgFTFSI), magnesium (fluorosulfonyl pentafluoroethanesulfonyl)imide (Mg[N(SO₂F)N(SO₂CF₂CF₃)]₂, MgFBETI), magnesium cyclo(tetrafluoroethylenedisulfonyl)imide (Mg [N(SO₂CF₂CF₂SO₂)]₂, MgCTFSI), magnesium (trifluoromethanesulfonyl)(n-nonafluorobutanesulfonyl)imide (Mg[N(SO₂CF₃)(SO₂-n-C₄F₉)]₂, MgTNFSI), or any combination thereof. In some aspects, the magnesium salt is Mg(PF₆)₂, MgTFSI, or a combination thereof.

Exemplary calcium salts for the electrolyte include, but are not limited to, Ca(PF6)2. calcium bis(trifluoromethanesulfonyl)imide (CaTFSI), calcium bis(fluorosulfonyl)imide (CaFSI), calcium bis(oxalato)borate (Ca[B(C₂O₄)₂]₂, CaBOB), calcium difluoro(oxalato)borate (Ca[BF₂(C₂O₄)]₂, CaDFOB), Ca(CF₃SO₃)₂, Ca(AsF₆)₂, Ca(BF₄)₂, Ca(SCN)₂, calcium bis(pentafluoroethanesulfonyl)imide (Ca[N(SO₂CF₂CF₃)₂]₂, CaBETI), calcium (fluorosulfonyl trifluoromethanesulfonyl)imide (Ca[N(SO₂F)(SO₂CF₃)]₂, CaFTFSI), calcium (fluorosulfonyl pentafluoroethanesulfonyl)imide (Ca[N(SO₂F)N(SO₂CF₂CF₃)]₂, CaFBETI), calcium cyclo(tetrafluoroethylenedisulfonyl)imide (Ca[N(SO₂CF₂CF₂SO₂)]₂, CaCTFSI), calcium (trifluoromethanesulfonyl)(n-nonafluorobutanesulfonyl)imide (Ca[N(SO₂CF₃)(SO₂-n-C₄F₉)]₂, CaTNFSI), or any combination thereof. In some aspects, the calcium salt is Ca(PF₆)₂, CaTFSI, or a combination thereof.

In any of the foregoing or following aspects, the solvent may comprise ethylene carbonate (EC), dimethyl carbonate (DMC), 1,2-dimethoxyethane (DME), 2,2,2-trifluoroethyl-3′,3′,3′,2′,2′-pentafluoropropyl ether (HFE), diglyme (bis-2(methoxyethyl) ether), vinylene carbonate (VC), fluoroethylene carbonate (FEC), difluoroethylene carbonate (DFEC), trifluoroethylene carbonate (TFEC), vinyl ethylene carbonate (VEC), 4-methylene ethylene carbonate (MEC), propylene carbonate (PC), 4,5-dimethylene-1,3-dioxolan-2-one (butylene carbonate), ethyl methyl carbonate (EMC), diethyl carbonate (DEC), methyl 2,2,2-trifluoroethyl carbonate (MFEC), dimethyl sulfone (DMS), ethyl methyl sulfone (EMS), ethyl vinyl sulfone (EVS), tetramethylene sulfone (TMS), trifluoromethyl ethyl sulfone (FMES), trifluoromethyl isopropyl sulfone (FMIS), trifluoropropyl methyl sulfone (FPMS), ethylene sulfite, ethylene sulfate, triglyme (tricthylene glycol dimethyl ether), tetraglyme (tetracthylene glycol dimethyl cther), tetrahydrofuran (THF), 1-methoxy-2-propylamine, or any combination thereof. In some implementations, the solvent comprises EC, DEC, DME, HFE, diglyme, or any combination thereof.

In some aspects, the electrolyte has a metal salt concentration from 0.5 M to saturation concentration or from 1 M to saturation concentration, such as from 0.5 M to 3 M, 0.5 M to 2 M, 0.5 M to 1.5 M, or 1 M to 1.5 M. In certain examples, the composite cathode comprises a Li salt, and the electrolyte is 1 M LiPF₆ in EC and DEC (1:1 by volume) or 1 M LiPF₆ in DME and HFE (1:3 by volume).

In some implementations, the electrolyte consists essentially of, or consists of, the metal salt and the solvent. In other aspects, the electrolyte may include one or more additives to induce uniform alkali metal deposition onto the anode and/or to promote the deposition/stripping efficiency of metal to/from the anode. Exemplary additives for lithium batteries include, but are not limited to, LiNO₃, LiFSI, LiBOB, LIFDOB, LiTFSI, VC, and combinations thereof.

### V. EXAMPLES

### Example 1

Cathode: Li₃PO₄·3/4Cu₂S, LiOH·1/4Cu₂S, HCOOLi·1/4Cu₂S, CH₃COOLi·1/4Cu₂S, Li₂CO₃·Cu, Li₃PO₄·3/2Cu and Li₂CO₃·MnCO₃ cathode powders were prepared by planetary ball milling. The precursors (the molar ratios between Li₃PO₄ and Cu₂S, LiOH and Cu₂S, HCOOLi and Cu₂S, CH₃COOLi and Cu₂S, Li₂CO₃ and Cu, Li₃PO₄ and Cu, Li₂CO₃ and MnCO₃ are 4:3, 4:1, 4:1, 4:1, 1:1, 2:3, and 1:1, respectively) and 10 to 20 wt % of graphite or KetjenBlack® carbon black were placed in the zirconia ball-milling pot and sealed in an argon-filled glove box. The rotational speed was controlled at 400 r.p.m. for 30 min followed by a rest for 10 min. The total ball-milling time was 50 hours, 1 hour, 2 hours, 2 hours, 25 hours, 25 hours, and 50 hours, respectively. The resulting Li₃PO₄·3/4Cu₂S, LiOH·1/4Cu₂S, HCOOLi·1/4Cu₂S, CH₃COOLi·1/4Cu₂S, Li₂CO₃·Cu, Li₃PO₄·3/2Cu, and Li₂CO₃·MnCO₃ composites were removed from the gas-sealed ball milling container within an argon filled glove box.

The cathode was fabricated in a glove box. The as-prepared Li₃PO₄·3/4Cu₂S, LiOH·1/4Cu₂S, HCOOLi·1/4Cu₂S, CH₃COOLi·1/4Cu₂S, Li₂CO₃·Cu, Li₃PO₄·3/2Cu, and Li₂CO₃·MnCO₃ powder powders were each ground with polytetrafluoroethylene (PTFE) at a weight ratio of 9:1 and then compressed on a titanium metal mesh (Alfa Aesar; 100 mesh). The areal loading of the cathode material was about 12-15 mg/cm².

Cell Setup: Li₃PO₄·3/4Cu₂S, LiOH·1/4Cu₂S, HCOOLi·1/4Cu₂S, CH₃COOLi·1/4Cu₂S, Li₂CO₃·Cu, Li₃PO₄·3/2Cu, and Li₂CO₃·MnCO₃ composite cathodes and a solution of 1.0 M LiPF₆ in ethylene carbonate (EC) and dimethyl carbonate (DEC) (1:1 by volume) or 1 M LiPF₆ in 1,2-dimethoxyethane (DME) and 2,2,2-trifluoroethyl-3′,3′,3′,2′,2′-pentafluoropropyl ether (HFE) (1:1 by volume) or 1.3 M LiTFSI in diglyme served as cathode and electrolyte, respectively. The anode could be any anode suitable for LIBs such as lithium metal, graphite, silicon, SiO, Si/C composite, Li₄Ti₅O₁₂, transition metal oxides, transition metal sulfides, etc. The primary example of an anode for a lithium battery is lithium metal.

Charge-Discharge Mechanism: In one possible mechanism, Cu₂S may act as a catalyst rather than an electron source. Without wishing to be bound by a particular theory of operation, the mechanism may be as shown in the following exemplary, non-limiting reactions. Interestingly, covalently bound anions may be oxidized as the battery charges.

$$\\ {Li}_{2} {CO}_{3} {⟶}^{{Cu}_{2} S} {{Li}^{}}^{+} + {LiCO}_{3} + {e}^{-} ,$$

$$\\ {Li}_{4} {CO}_{3} {SO}_{4} {⟶}^{{Cu}_{2} S} 2 {{Li}^{}}^{+} + {Li}_{2} {CO}_{3} {SO}_{4} + 2 {e}^{-} ,$$

$$\\ {Li}_{4} {CO}_{3} {SO}_{4} {⟶}^{{Cu}_{2} S} 3 {{Li}^{}}^{+} + {LiCO}_{3} {SO}_{4} + 3 {e}^{-}$$

In another possible mechanism, upon charging, Cu₂S may be converted to S₈ and CuA₂, where the anions of A⁻ come from partially solvated LiA. The solvated Li⁺ ions from LiA will migrate through the electrolyte and be plated on the lithium metal anode. The electrons will flow from the cathode through the external circuit and arrive at the anode side. The discharge process is a reverse process. Upon discharge, Li-ions will be stripped from the lithium metal anode and attack CuA₂ to form LiA and Cu²⁺ reacts with sulfur to form Cu₂S. The whole electrochemical charge/discharge process can be described by the following quasi-metathesis reaction:

Cu₂S (s)+4LiA (s)↔2CuA₂ (s)+S (s)+4Li⁺ (sol)+4e⁻

### Results:

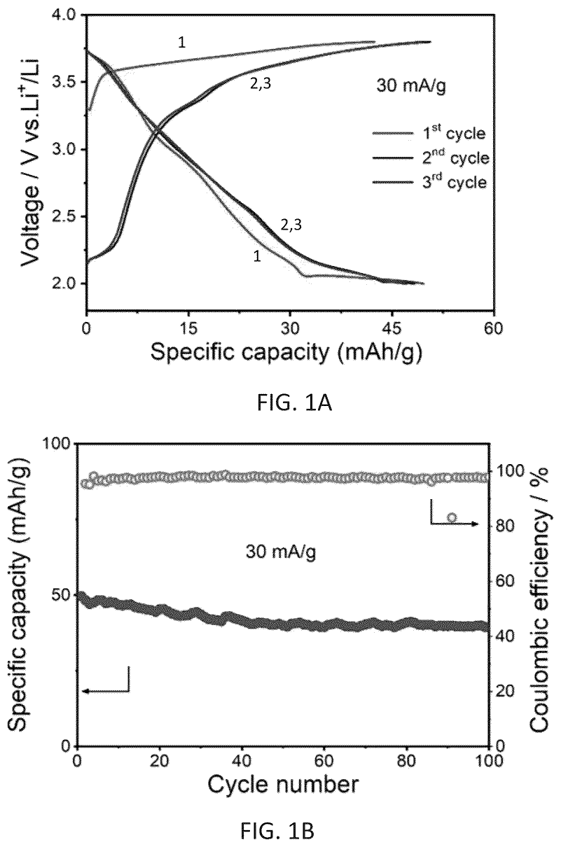

The electrochemical performance of the Li₃PO₄·3/4Cu₂S cathode was evaluated in a two-electrode coin cell with lithium metal as the anode. The cutoff window was 2.0-3.8 V. A glass fiber membrane served as a separator, and Li metal was both the anode and the reference electrode. The electrolyte was 1 M LiPF₆ in EC and DEC (1:1 by volume). As shown in FIG. 1A, the Li₃PO₄·3/4Cu₂S cathode delivered a high capacity of 50 mAh/g (based on the mass of Li₃PO₄ and Cu₂S) with a high average voltage of ˜2.7 V at a current rate of 30 mA/g. The Li₃PO₄·3/4Cu₂S cathode exhibited a stable cycling life with 80% capacity retention for 100 cycles (FIG. 1B).

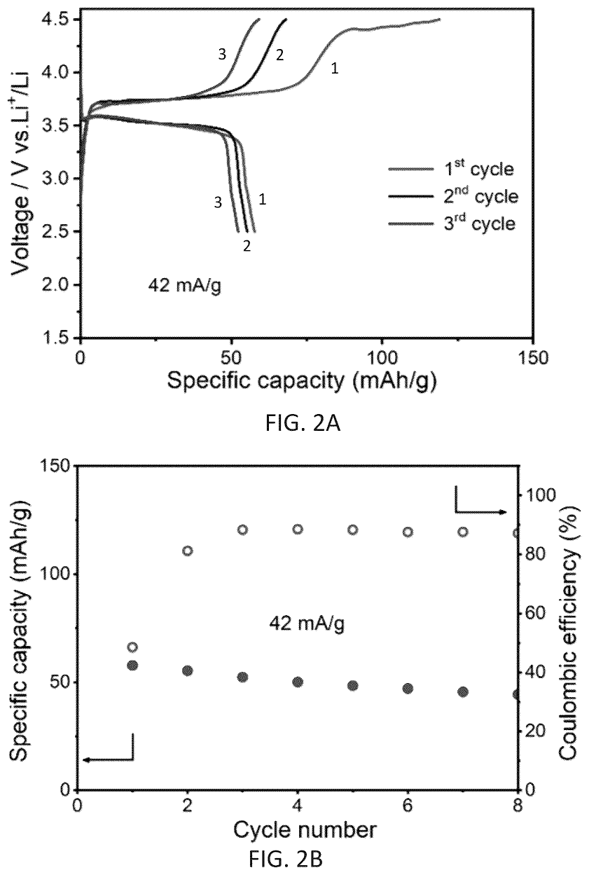

The electrochemical performance of the LiOH·1/4Cu₂S cathode was evaluated in a two-electrode coin cell with lithium metal as the anode. The cutoff window was 2.5-4.5 V. A glass fiber membrane served as the separator, and Li metal was both the anode and the reference electrode. The electrolyte was 1 M LiPF₆ in DME and HFE (1:3 by volume). The LiOH·1/4Cu₂S cathode delivered a discharge capacity of 58 mAh/g (based on the mass of LiOH and Cu₂S) with a relatively high voltage plateau at 3.5 V at a current rate of 42 mA/g (FIG. 2A), and it also exhibited relatively high-capacity retention during cycling (FIG. 2B).

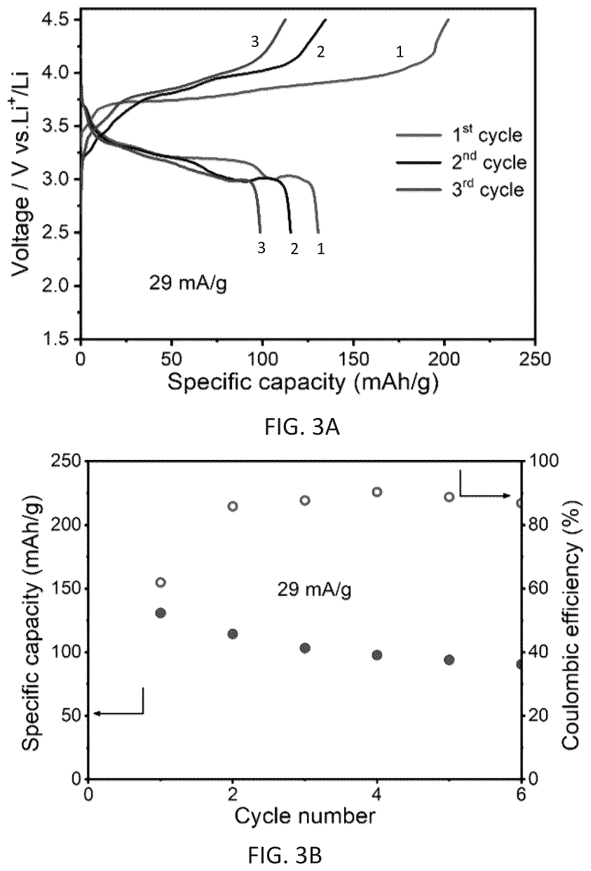

The electrochemical performance of the HCOOLi·1/4Cu₂S cathode was evaluated in a two-electrode coin cell with lithium metal as the anode. The cutoff window was 2.5-4.5 V. A glass fiber membrane served as a separator, and Li metal was both the anode and the reference electrode. The electrolyte was 1 M LiPF₆ in DME and HFE (1:3 by volume). HCOOLi·1/4Cu₂S cathode delivered a high discharge capacity of 130 mAh/g (based on the mass of HCOOLi and Cu₂S) with a relatively high voltage plateau at 3.2 V at current density of 29 mA/g (FIG. 3A). The HCOOLi·1/4Cu₂S cathode showed a fast fading in discharge capacity with cycling (FIG. 3B), and the polarization between charge and discharge was high, which resulted in a low energy efficiency.

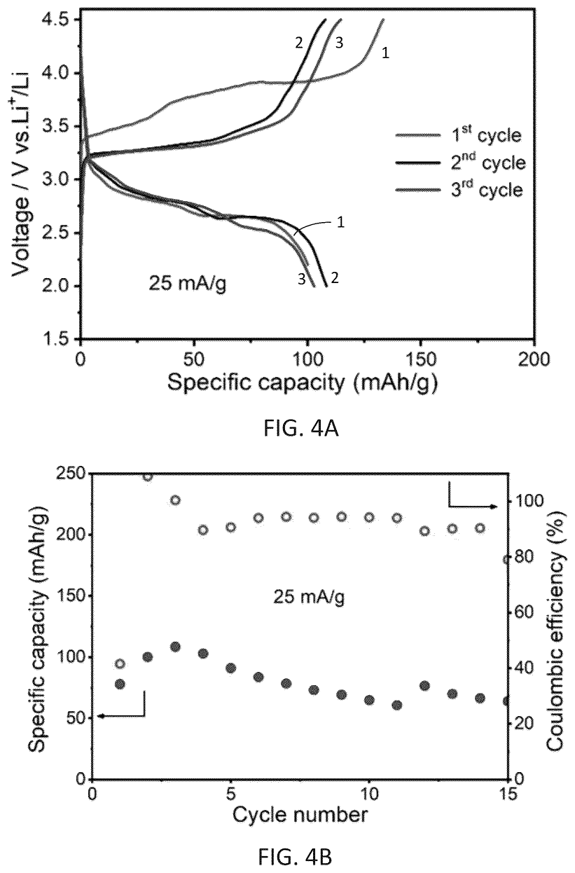

The electrochemical performance of the CH₃COOLi·1/4Cu₂S cathode was evaluated in a two-electrode coin cell with lithium metal as the anode. The cutoff window was 2.0-4.5 V. A glass fiber membrane served as a separator, and Li metal was both the anode and the reference electrode. The electrolyte was 1 M LiPF₆ in DME and HFE (1:3 by volume). The CH₃COOLi·1/4Cu₂S cathode delivered a high discharge capacity of 110 mAh/g (based on the mass of HCOOLi and Cu₂S) with a relatively high voltage plateau at 2.8 V at current density of 25 mA/g (FIG. 4A). The CH₃COOLi·1/4 cathode exhibited fast fading in discharge capacity with cycling (FIG. 4B).

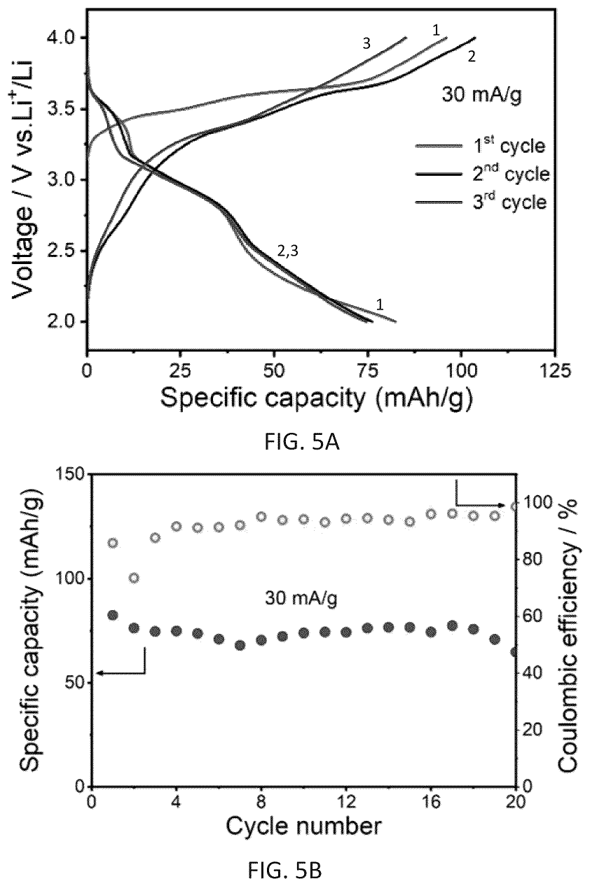

The electrochemical performance of the Li₂CO₃·Cu cathode was evaluated in a two-electrode coin cell with lithium metal as the anode. The cutoff window was 2.0-4.0 V. A glass fiber membrane served as a separator, and Li metal was both the anode and the reference electrode. The electrolyte was 1 M LiPF₆ in EC and DMC (1:1 by volume). The Li₂CO₃·Cu cathode delivered a discharge capacity of 83 mAh/g (based on the mass of Li₂CO₃ and Cu) with a relatively high voltage plateau at 2.8 V at current density of 30 mA/g (FIG. 5A). The Li₂CO₃·Cu cathode showed a relatively stable capacity with cycling (FIG. 5B).

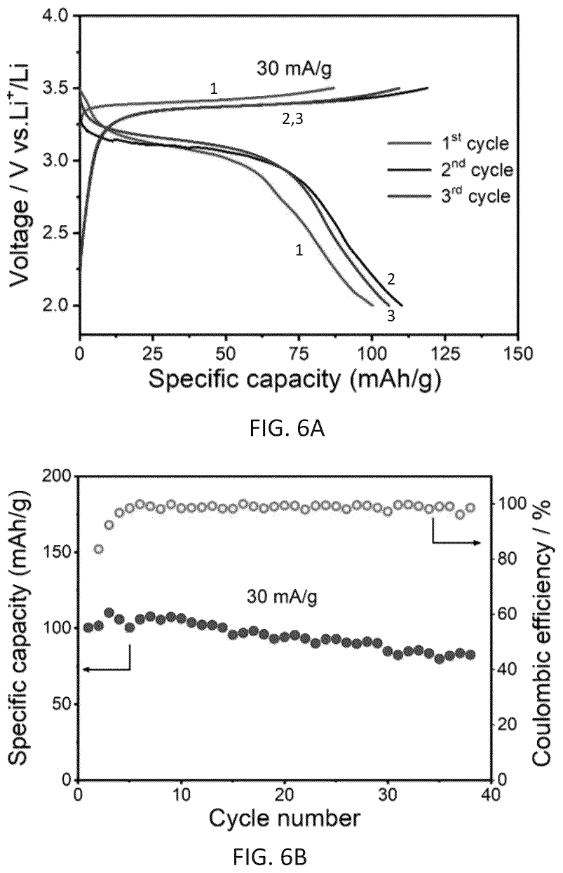

The electrochemical performance of the Li₃PO₄·3/2Cu cathode was evaluated in a two-electrode coin cell with lithium metal as the anode. The cutoff window was 2.0-3.5 V. A glass fiber membrane served as a separator, and Li metal was both the anode and the reference electrode. The electrolyte was 1 M LiPF₆ in EC and DEC (1:1 by volume). The Li₃PO₄·3/2Cu cathode delivered a high discharge capacity of 110 mAh/g (based on the mass of Li₃PO₄ and Cu) with a relatively high voltage plateau at 3.0 V at current density of 30 mA/g (FIG. 6A). The Li₃PO₄·3/2Cu cathode exhibited a relatively stable capacity with cycling (FIG. 6B).

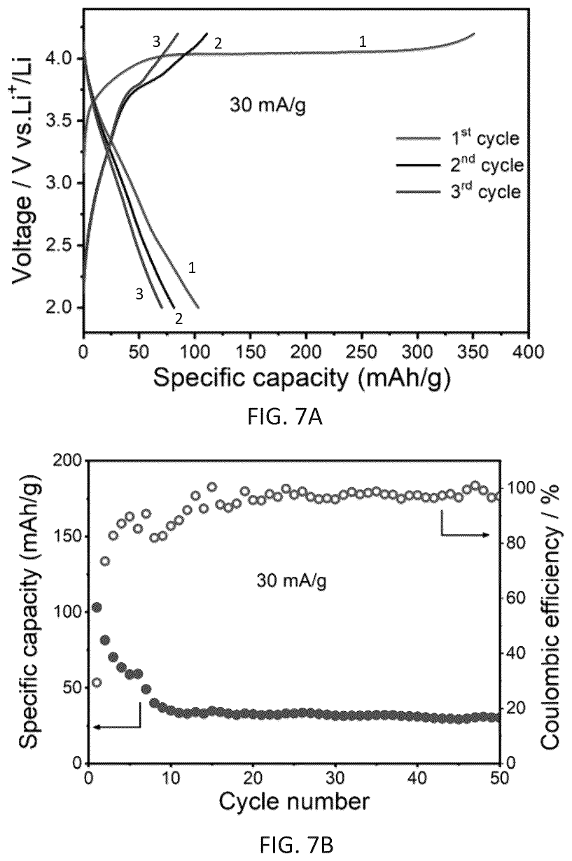

The electrochemical performance of the MnCO₃·Li₂CO₃ cathode was evaluated in a two-electrode coin cell with lithium metal as the anode. The cutoff window was 2.0-4.2 V. A glass fiber membrane served as a separator, and Li metal was both the anode and the reference electrode. The electrolyte was 1.0 M LiPF₆ in EC and DEC (1:1 by volume). The MnCO₃·Li₂CO₃ cathode delivered a high discharge capacity of 103 mAh/g (based on the mass of MnCO₃ and Li₂CO₃) with a relatively high voltage plateau at 3.0 V at current density of 30 mA/g (FIG. 7A). But, the MnCO₃·Li₂CO₃ cathode exhibited a fast fade in capacity with cycling (FIG. 7B).

The composite cathodes provided reversible capacities versus Li⁺/Li at 30 mA/g as shown in Table 1:

TABLE 1

| | Reversible Capacity | Average Potential |
|---|---|---|
| Cathode | (mAh/g) | (V) |
| Li₃PO₄•3/4Cu₂S | 50 | 2.7 |
| LiOH•1/4Cu₂S | 58 | 3.5 |
| HCOOLi•1/4Cu₂S | 130 | 3.2 |
| CH₃COOLi•1/4Cu₂S | 110 | 2.8 |
| Li₂CO₃•Cu | 83 | 2.8 |
| Li₃PO₄•3/2Cu | 110 | 3.0 |
| Li₂CO₃•MnCO₃ | 103 | 3.0 |

### Example 2

Synthesis of IronPF composite. The IronPF composite was prepared with Li₃PO₄ (TCI AMERICA), LiF (Thermo Fisher Scientific), iron powder (Sigma-Aldrich), and graphite (Sigma Aldrich) without any prior purification. Li₃PO₄, LiF, and iron powder, in the molar ratio of 3:3:4 (6:3:7 and 3:6:5), were added to a planetary ball mill (Pulverisette® 6; Fritsch International, Pittsboro, NC) along with an additional 20 wt. % graphite. The mixture was sealed in an Ar-filled glovebox with H₂O and O₂ concentrations below 0.1 ppm. The powders in the bowl were subjected to ball milling at 400 r.p.m. for 50 hours, with a 5-minute break every 30 minutes.

Synthesis of Fe/Li₃PO₄ and LiF composites. The Fe/Li₃PO₄ and LiF composites was prepared in the same way as the synthesis of the IronPF composite except for the components and molar ratios. These composites were processed by ball milling (Pulverisette® 6; Fritsch International) a mixture comprising bulk iron powder, individual lithium salts, and graphite (20 wt. %) under an Ar atmosphere with Fe/LiₓA molar ratios corresponding to the three-electron transfer of iron to form ferric FeₓA_{3.}

Synthesis of Fe/graphite composite. The Fe/graphite composite was prepared in the same way as the synthesis of the IronPF composite. A mixture of iron and graphite with a mass ratio of 4:1 was processed by ball milling (Pulverisette® 6; Fritsch International) without the presence of lithium salts.

Materials characterization. X-ray diffraction (XRD) patterns were collected on a Rigaku Ultima IV diffractometer (Rigaku Corporation, Tokyo, Japan) with the Cu Kα radiation (λ=1.5406 Å). The microstructure and morphology were measured by using FEI NOVA 230 field-emission scanning electron microscopy (FESEM; FEI Company, Hillsboro, OR). Scanning transmission electron microscopy (STEM) and its corresponding energy-dispersive X-ray spectroscopy (EDX) was conducted on FEI Titan 80-300 high-resolution scanning transmission electron microscopy with four embedded Bruker silicon drift detectors (SDD) (Bruker, Madison, WI). To prepare the samples, the corresponding cells were disassembled, and the electrodes were washed with DMC and dried in an Ar-filled glovebox. The electrodes were sealed using Kapton® tape (Kapton Tape, Torrance, CA) to avoid air exposure.

Electrochemical measurements. The working electrode comprised 80 wt. % active materials (IronPF, Fe/Li₃PO₄, Fe/LiF, or Fe/Graphite), 10 wt. % KetjenBlack (KB) carbon, and 10 wt. % polyvinylidene fluoride (PVdF) binder. Conductive carbon-coated aluminum foil (MTI Corp) was used as the current collector. N-methyl-2-pyrrlidinone (NMP, TCI) solvent was used to make the cathode slurry. The slurry-coated current collectors were dried under vacuum at 60° C. for 12 hours, then punched into discs of 12 mm in diameter. Li foil was used as the counter and reference electrodes. Glass fiber membranes (GF/F, Whatman) were employed as the separator. The mass loading of the electrodes was ca. 2.1-2.5 mg/cm², and the specific capacity of the electrodes was calculated based on the mass of Fe and the corresponding lithium salts. LiPF₆, 1 M, in ethylene carbonate/diethyl carbonate (EC/DEC, 1:1 by volume) was used as the electrolyte. The cells were assembled in an Ar-filled glovebox with the concentration of H₂O and O₂ below 0.1 ppm. The electrochemical performance of the cathodes was tested on a Landt CT3002A battery testing system (Landt Instruments, Vestal, NY) at various current rates. The cutoff potential window was set to 1.5-4.7 V vs. Li⁺/Li. Cyclic voltammetry (CV) and electrochemical impedance spectroscopy (EIS) were tested on a VMP-3 multichannel workstation (Biologic, Seyssinet-pariset, France) at a scan rate of 0.2 mV/s and a frequency range of 0.01 to 105 Hz, respectively.

The GITT experiment utilized a coin device. The cycling process involved current pulses of 30 mA/g for 20 minutes, alternating with 120-minute rest to attain quasi-equilibrium potentials. The apparent ionic diffusion coefficients (D) of the composite cathode at different states of charge were estimated from the GITT measurement using the following relation:

$$\\ D = \frac{4}{π τ} {( \frac{{R}_{s}}{3} )}^{2} {( \frac{Δ {E}_{s}}{Δ {E}_{t}} )}^{2}$$

τ=rest time, Rₛ=radius of the particles, ΔEₛ=voltage change induced by constant current pulses, ΔEₜ=voltage change during constant current pulses.

Galvanostatic electrochemical impedance spectrometry (GEIS). GEIS was conducted using a VMP-3 electrochemical workstation (Biologic, Seyssinet-pariset, France). Cells were run 10 cycles in the Landt battery cycler (1.5 V to 4.7 V. 100 mA g⁻¹) and transferred to a 30° C. oven. After 3 hours of rest, 30 mA g⁻¹ constant current charge-discharge cycles were run. During these cycles using DC inputs, EIS measurement was conducted by adding AC signals of 10 mA g⁻¹ amplitude to the DC signal. To minimize the influence of AC signals on the cycling performance of the cell, 15-minute intervals were used between every EIS measurement. The frequency range used was 200 kHz to 2 Hz, and each measurement took about 27 seconds to complete. Lower frequencies were not used because continuous increase/decrease of voltage during charge/discharge made the low-frequency data extremely noisy and unreliable. A distribution of relaxation time (DRT) analysis was conducted for all EIS data using MATLAB-based DRTtools developed by T. H. Wan et al. (Electrochimica Acta 2015, 184:483-499). Default parameters were used to calculate γ(ln τ) vs τ.

### Results and Discussion

### 1. Screening Lithium Salts for the Iron-Based Lithium-Salt Composite (LSC)

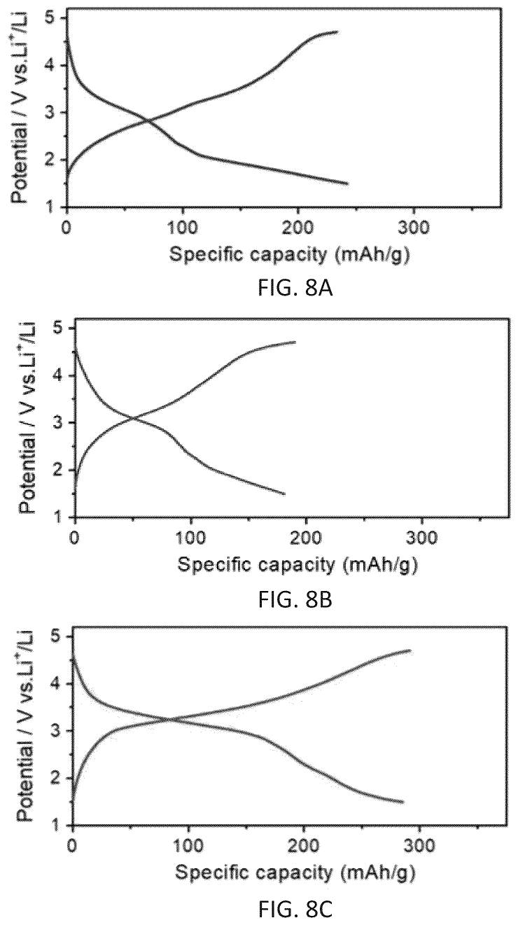

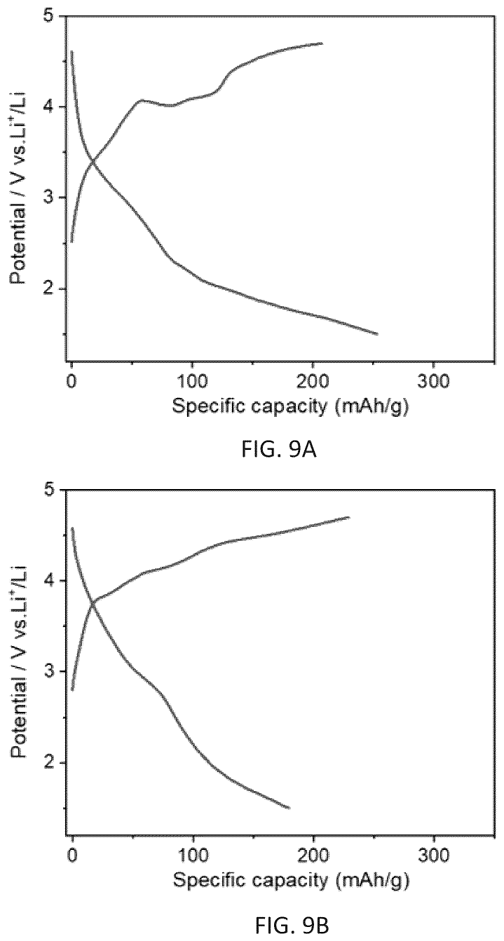

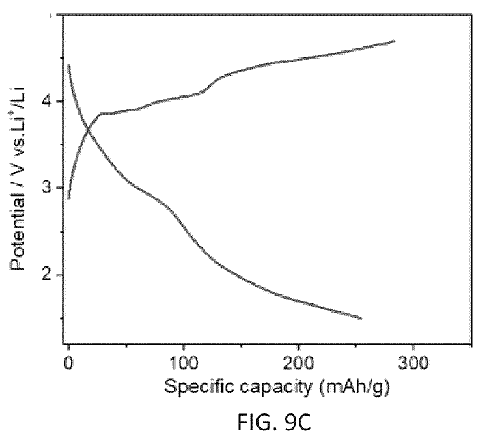

Fe/LiₓA LSC cathodes with different anions having high charge/mass ratios, including F⁻, and PO₄³⁻, were screened by comparing their galvanostatic charge-discharge (GCD) performance. These composites were processed by ball milling a mixture comprising bulk iron powder, individual lithium salts, and graphite (20 wt. %) under an Ar atmosphere with Fe/LixA molar ratios corresponding to the three-electron transfer of iron to form ferric FeₓA₃. As known, ball milling exfoliates graphite into graphene sheets (Zhao et al., J. Mater. Chem. 2010, 20:5817-5819), thus providing an electronic conduit for lithium salts (Teng et al., Adv. Funct. Mater. 2017. 27:1700240). Fe/LiF exhibited a reversible capacity of 242 mAh/g with an average discharge potential of 2.4 V, where more than 60% of its capacity comes from the lower quasi-plateau below 2 V, which is similar to the previous reports (FIG. 8A) (Liao et al., Chem. Mater. 2008, 20:454; 461; Badway et al., Materials Research Society Symposium—Proceedings 2003, 756:207-218; Prakash et al., J. Power Sources 2011, 196:5936-5944). Notably, Fe/Li₃PO₄ exhibited a reversible discharge at 181 mAh/g with 30% of its capacity below 2 V (FIG. 8B). Of note, both Fe/LiF and Fe/Li₃PO₄ composite electrodes displayed significant potential hysteresis in the first cycle (FIGS. 9A-9C), where the first charging potential was significantly higher than the potentials of later charging processes. Notably, the hysteresis shrunk with cycling, where the initial cycles served as a conditioning process.

2. Anion Solid Solution Mixed with Iron

Considering that Fe/LiF favors a high utilization of iron and Fe/Li₃PO₄ confers a high discharge potential, and that anion mobility plays a large role in the operation of LSC electrodes, it was postulated that the presence of a solid solution of PO₄³⁻ and F⁻ in the LSC electrode might integrate the benefits of both Fe/LiF and Fe/Li₃PO₄ systems. Cation solid solutions are widely employed to improve the performance of cathode materials of LIBs such as in layered metal oxide cathodes (Madhavi et al., Power Sources 2001, 93:156-162) and anionic solid solutions, particularly the fluoride-phosphates (Xiong et al., Russ. J. Electrochem. 2014, 50:1003-1007; Tripathi et al., Angew. Chem. Int. Ed. 2010, 49:8738-8742) In the conventional LIB cathodes, anions such as oxides, phosphate, or structures with two anions are the building blocks of the ordered structural frameworks, which are deemed immobile in battery cycling. However, in an amorphous LSC cathode, the transport of anions is necessary for the electrode charging. The role of the anions was investigated with a solid solution of PO₄³⁻ and F⁻ in an amorphous structure.

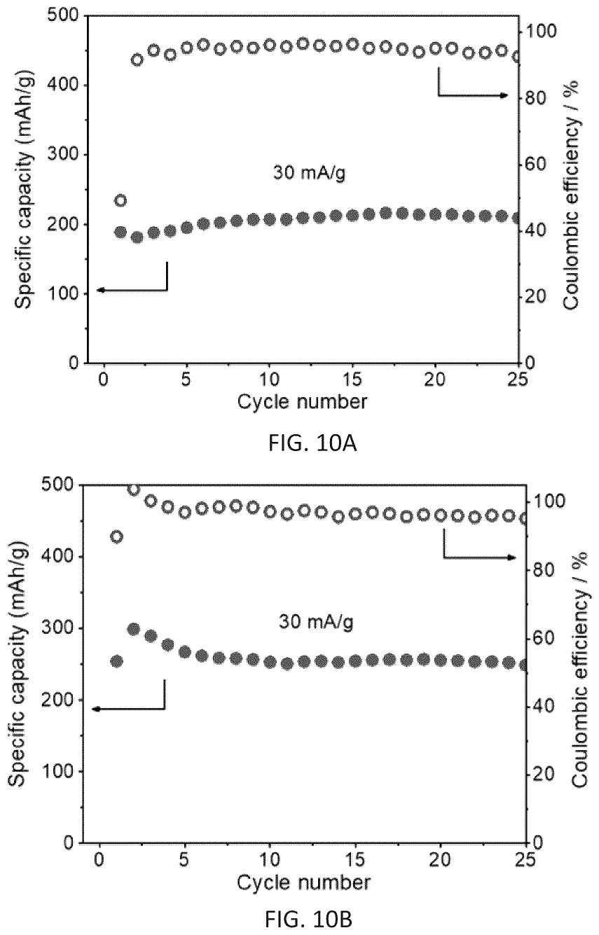

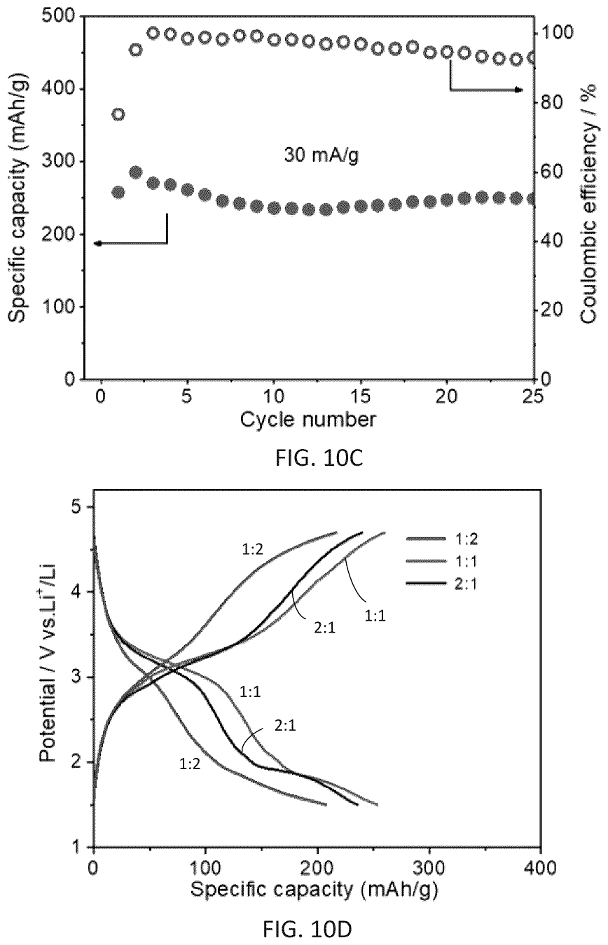

The performances of the ternary composite electrodes formed by ball milling the pertinent salts and iron with different molar ratios of Li₃PO₄ and LiF: 1:2, 1:1, and 2:1 were compared. The 1:1 ratio exhibited the optimal performance with the highest capacity and Coulombic efficiency (FIGS. 10A-10D). This composite has the stoichiometry of the Fe₄(Li₃PO₄)₃(LiF)₃, which is referred to as IronPF and was selected for the following studies.

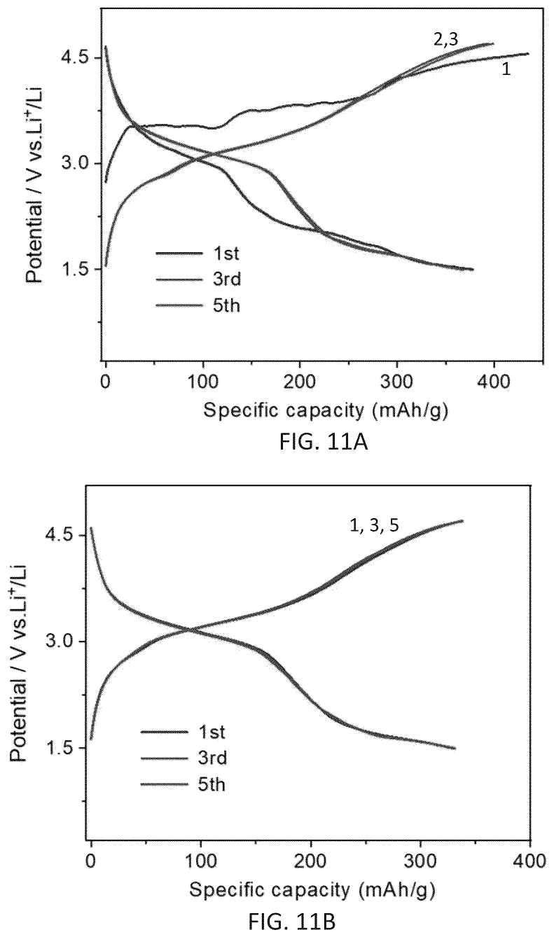

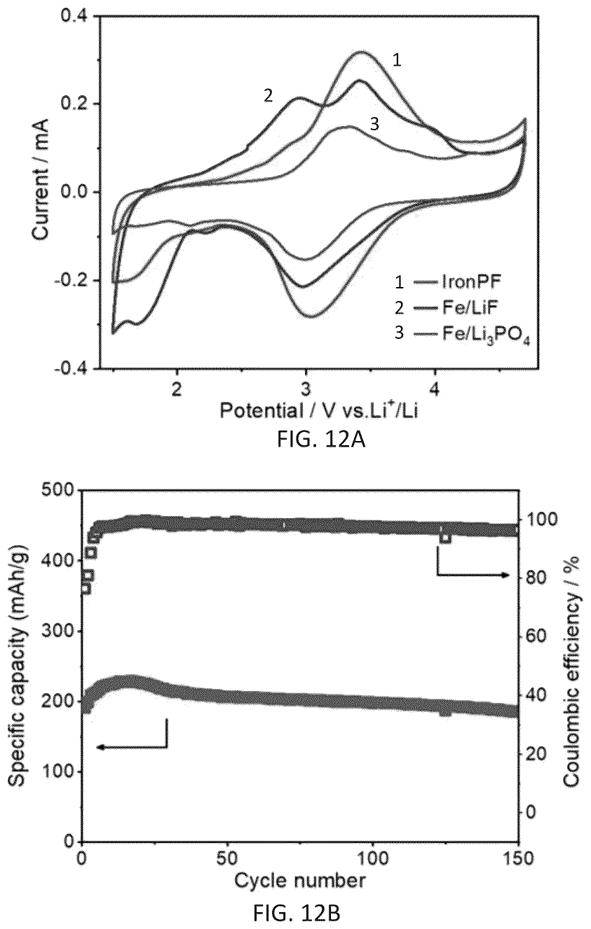

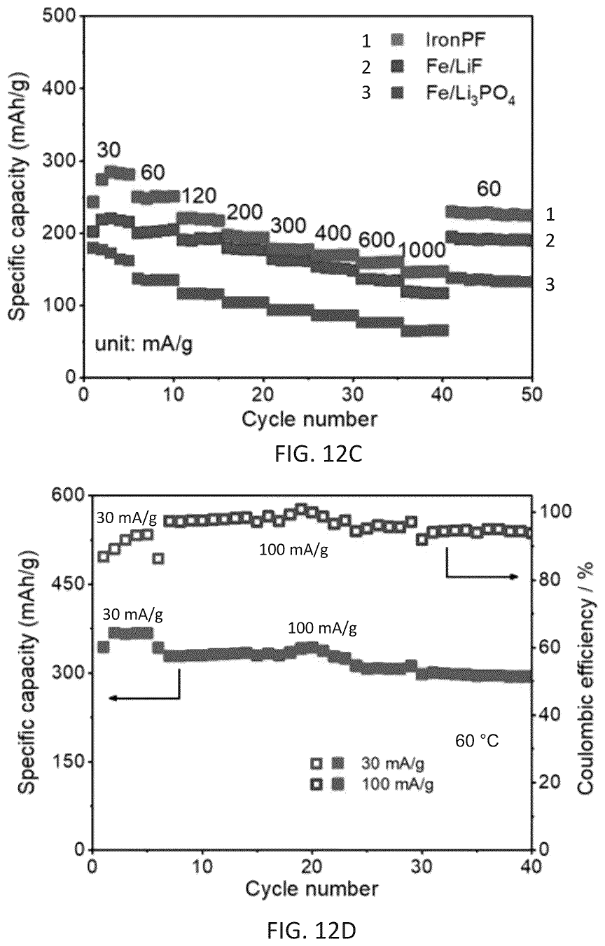

IronPF integrated the attributes of both iron/LiF and Fe/Li₃PO₄ by delivering a high reversible discharge capacity of 285 mAh/g at a current rate of 30 mA/g at an average discharge potential of 2.8 V, corresponding to energy comparable to the most energetic NCA and NMC cathodes (FIG. 8C). At 60° C., IronPF exhibited a higher capacity of 368 mAh/g, corresponding to an energy density of over 940 Wh/kg (FIGS. 11A-11B). The cyclic voltammetry (CV) curves (FIG. 12A) further illustrate the enhanced redox behavior of the ternary electrode. The IronPF electrode exhibited stable cycle life at 100 mA/g (FIG. 12B). In addition, IronPF, as a conversion electrode, showed good rate capability by retaining a capacity of 146 mAh/g at 1000 mA/g, in contrast to 118 mAh/g and 65 mAh/g for Fe/LiF and Fe/Li₃PO₄, respectively, at the same current rate (FIG. 12C). The IronPF electrode also exhibited stable cycle life at both 30 mA/g and 100 mA/g at an elevated temperature (60° C.) (FIG. 12D).

### 3. Operation Mechanism of the IronPF Cathode

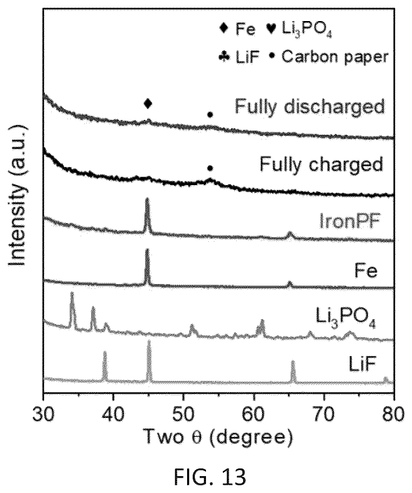

The iron electrode was characterized at various state of charge (SOC). As shown by X-ray diffraction (XRD) patterns (FIG. 13), ball milling reduced the crystalline salts of LiF and Li₃PO₄ phases to be amorphous. After ball milling, iron remained crystalline but with a much smaller coherence length, i.e., 260 nm, according to the Scherrer equation. XRD patterns revealed that the first charge transformed the crystalline iron into a glassy iron salt phase, and subsequent discharge did not restore the crystallinity of the iron phase.

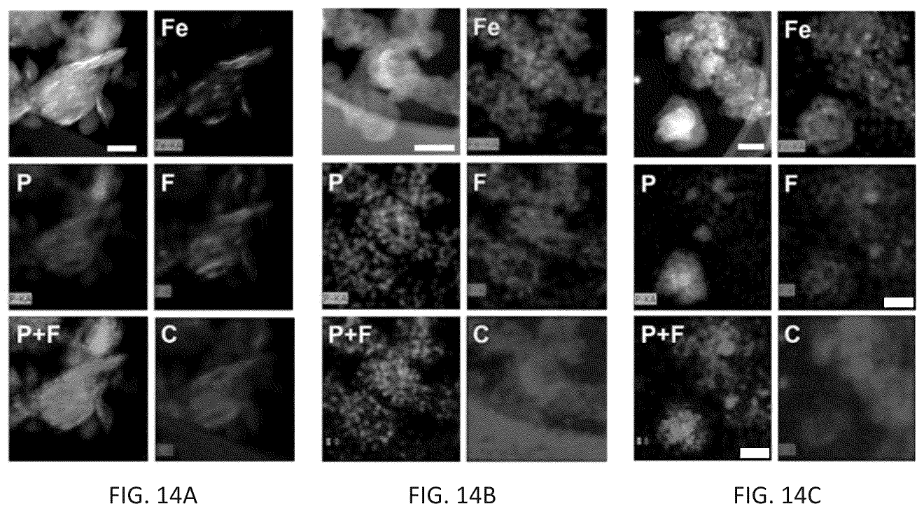

Scanning transmission electron microscopy (STEM) imaging and the corresponding energy-dispersive X-ray spectroscopy (EDX) mappings revealed a unique composite structure of the pristine IronPF composite. Embedded in the composite particles, iron domains, as shown by the brighter pixels inside STEM images and the EDX mapping, existed as nano-chips, 100 nm to 200 nm long (FIG. 14A). The anions of fluoride and phosphate were well mixed in this composite albeit with fluoride enriched around the iron chips. Carbon from 20 wt. % graphite was uniformly distributed in the composite after ball milling. The better electrochemical properties of IronPF raised the question of whether a solid solution of phosphate and fluoride is retained after the charging process in the resulting iron salts and after the discharging process in the resulting lithium salts/iron composite. As shown in FIG. 14B, after charging, the “shiny” iron nano-chips vanished, and all EDX signals of iron, phosphorus, and fluorine completely overlapped across the composite particles, thus forming a single complex glassy phase. After the following discharge, the P and F signals remained mixed but with a minor phase separation at a nanoscale, as shown in FIG. 14C. The STEM/EDX results demonstrated that throughout the cycling, the anions of phosphate and fluoride constituted a homogeneous anion solid solution after charging and remained well mixed at the discharged state. After discharge, iron signals in the EDX mapping became more locally concentrated, which matched the bright pixels in the STEM imaging, attributed to the metallic iron particles. The results indicate that the discharge process reversibly converts iron salts back to iron metal.

### 4. Kinetics and Anion Transport in the Lithium-Salt-Composite Cathode

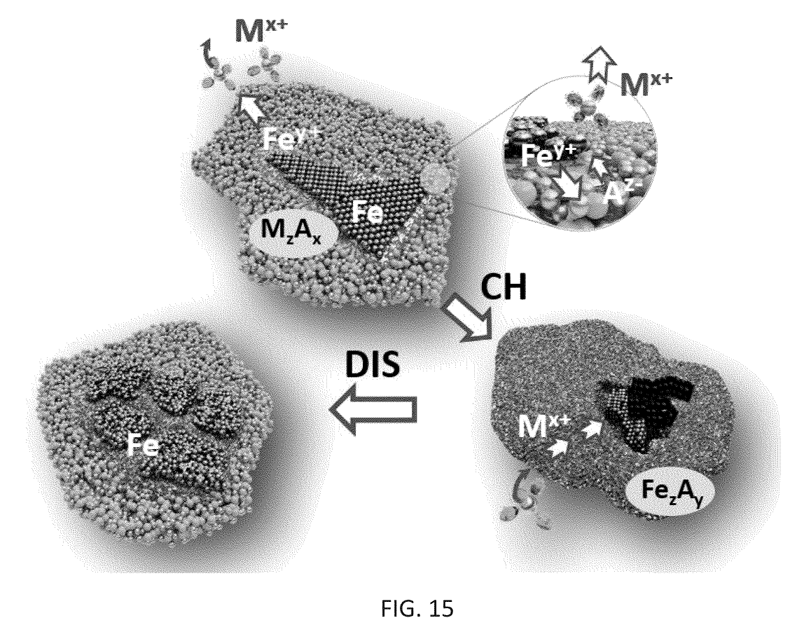

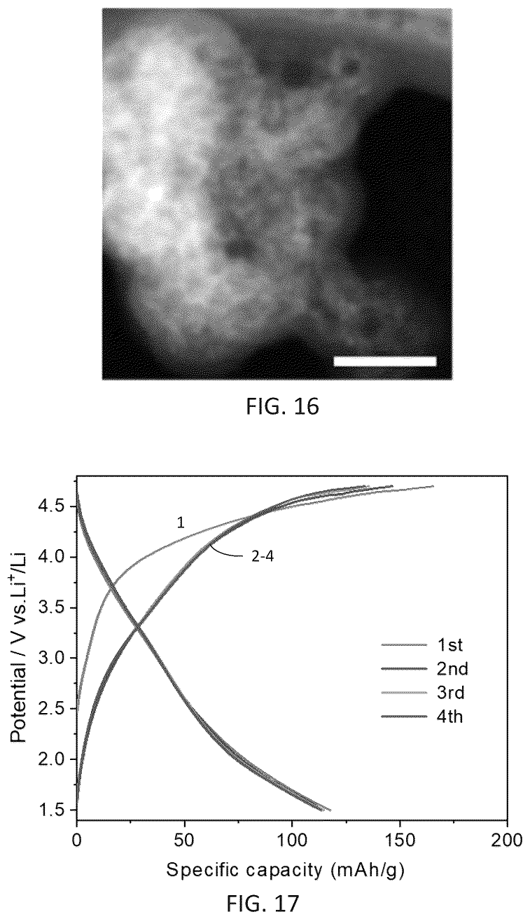

The observed charging capacity of all lithium-salt-composite (LSC) electrodes suggests the proceeding of the thermodynamically demanded transport of anions during the oxidation of iron (Mair et al., Chem. Mater. 2014, 26:348-360). As shown in FIG. 15, during charge, MₓA_{y} dissociates, where M-ions on the surface of the MₓA_{y} domains are solvated by the electrolyte, and a coordinating anion either migrates inward or is charge-compensated by an incoming M-ion from the inner parts of the domain. Taking LiF as an example, upon solvating a Li-ion, the F⁻ ion will be incorporated in the formation process of iron fluorides. Since F⁻ cannot be dissolved and transported by the electrolyte to the iron/iron fluoride interface, either solid-state transport of F⁻ takes place or stripped Fe-ions migrate toward the surface of LiₓA domains (FIG. 15). For the discharge process, the desolvated Li-ions attack the iron salts to form LiₓA salts and iron metal, where this process is more likely to be controlled by Li-ion conduction through the amorphous LiₓA. STEM results (FIG. 16) show that after charging, the composite electrode exhibits a hollow shell structure, where the holes are about 20 to 30 nm in size. The hollow shell structure suggests that Fe-ions are stripped from iron metal during charge, and these Fe-ions are moving outward. On the other hand, the sizes of holes are smaller than the domain size of iron (100 to 200 nm), as shown by FIG. 14A, which indicates that anions have moved to intercept Fe-ions. The anion transport under the electric field across the LiₓA phase and the resulting iron salts obeys the Mott-Cabrera mechanism (Qiu et al., Phys. Rev. Lett. 2000, 85:1492). The anion transport can be promoted by the amorphous lithium salt phases that contain ample structural defects and grain boundaries (Kaspar et al., Adv. Mater. Interfaces 2021, 8:2001768). It is a question whether phosphate can serve as the charge carrier for the cathode. To address this question, a ball-milled composite graphite and Li₃PO₄ with a mass ratio of 1:4 was prepared. Impressively, this LSC cathode exhibited a reversible capacity of 117.5 mAh/g and its GCD profiles differed from the storage of PF₆⁻ anions from the electrolyte in dual-ion batteries (FIG. 17) (Fromm et al., ECS Transactions 2014, 58:55; Seel et al., J. Electrochem. Soc. 2000, 147:892). The results suggest the solid-diffusion of PO₄³⁻ as the charge carriers for the anodic oxidation of the graphite active mass.

The transport of cations (Li⁺ and Fe³⁺) and anions (F⁻ and PO₄³⁻) across tens of nanometers during the charge and discharge of the LSC cathodes is complex and beyond first principles atomistic modeling. Because solid-state Li⁺ transport is fast due to its smaller size, it was postulated that Fe³⁺ and F⁻/PO₄³⁻ diffusions are the bottleneck, which can be facilitated by the anion solid solution.

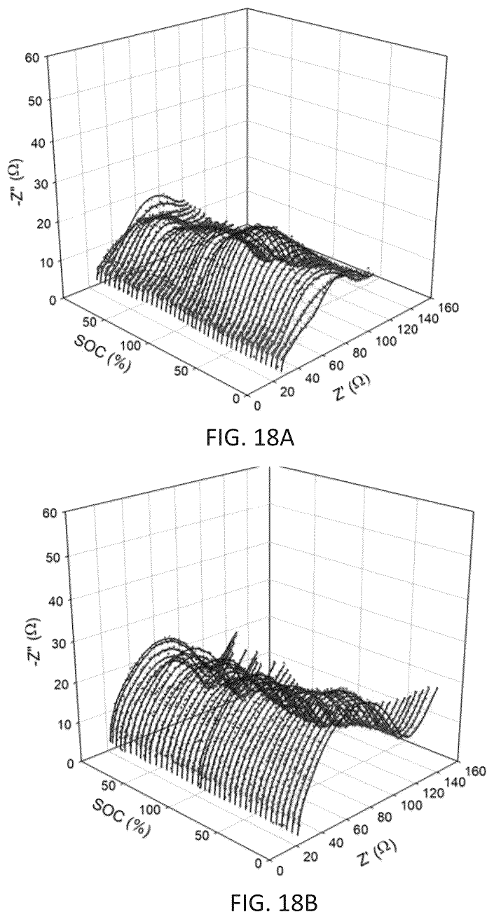

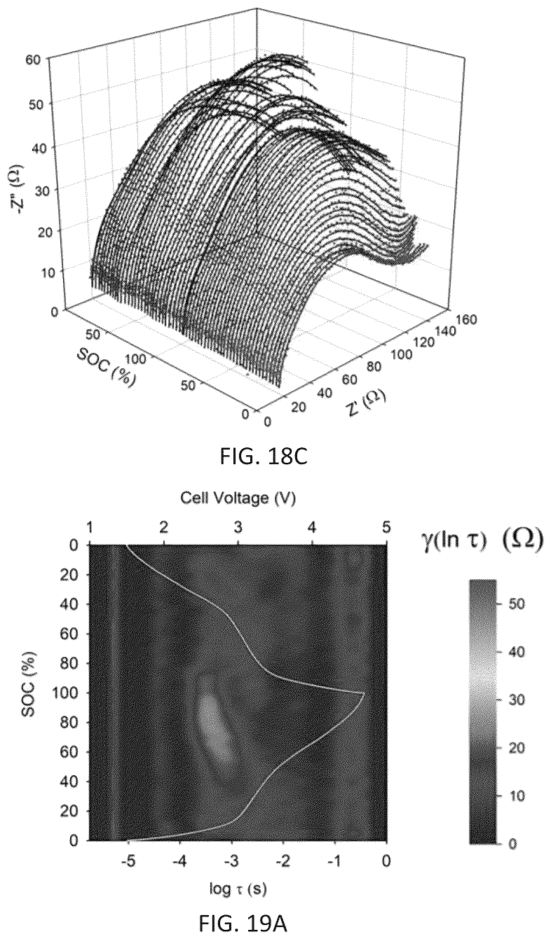

To further unravel the kinetic and transport properties of the LSC cathodes, galvanostatic electrochemical impedance spectroscopy (GEIS) measurements over half cells were conducted. In GEIS, the periodic sinusoidal current formed by overlapping an AC current and a DC current served as the perturbation, and the resulting voltage was recorded to generate the impedance spectra. The GEIS differs from the conventional EIS data because the testing cell does not flip the direction of the electrode polarization during the measurement. FIGS. 18A-18C show the Nyquist plots of GEIS spectra at different state of charge (SoC) for three composite electrodes: IronPF (FIG. 18A), Fe/Li₃PO₄ (FIG. 18B), and Fe/LiF (FIG. 18C). A simple comparison shows that Fe/LiF had a higher impedance than the other two composites. In order to understand more detailed kinetic and transport properties, an analysis of the distribution of relaxation times (DRT) with the DRT curves fitting the experimental data was carried out, where the impedance data was deconvoluted into several RQ circuits connected in series with increasing time constants.

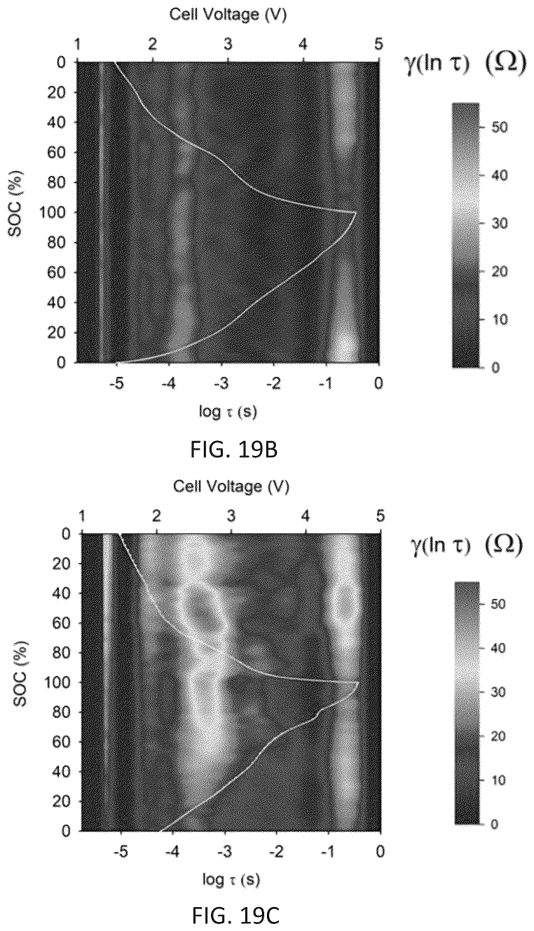

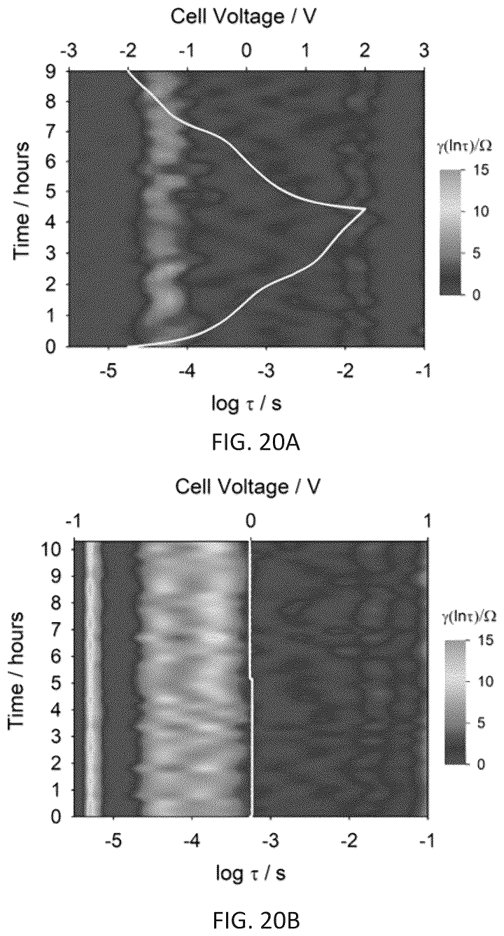

FIGS. 19A-19C depict the DRT results of the electrodes as a function of SoC for a full cycle. The DRT results exhibited four primary components with characteristic time constants, where the component faster than 1×10⁻⁵ s should be attributed to the electronic contacts, i.e., the equivalent series resistance, R_{ESR} of the half cells and the R_{ESR} of the IronPF electrode is the lowest. The next component with a time constant between 1×10⁻⁵ s and 1×10⁻⁴ s can be attributed to the charge transfer on the iron/iron salts interface, i.e., R_{CT-LSC}, by comparing to the GEIS of the IronPF∥IronPF symmetric cells (FIG. 20A). The IronPF electrode exhibited the smallest R_{CT-LSC}, which demonstrates the advantages of ion transport, i.e., Fe-ions and anions, across the interphase of the electrode. By comparing the R_{CT-LSC} of different LSC cathodes for the discharge process, one can conclude that the solid solution is particularly conducive to Li-ion conduction where the discharge transfer resistance is smaller for IronPF than Fe/LiF and Fe/Li₃PO₄. In particular, the large discharge R_{CT-LSC} of Fe/LiF explains the significant potential hysteresis of the Fe/LiF electrode.

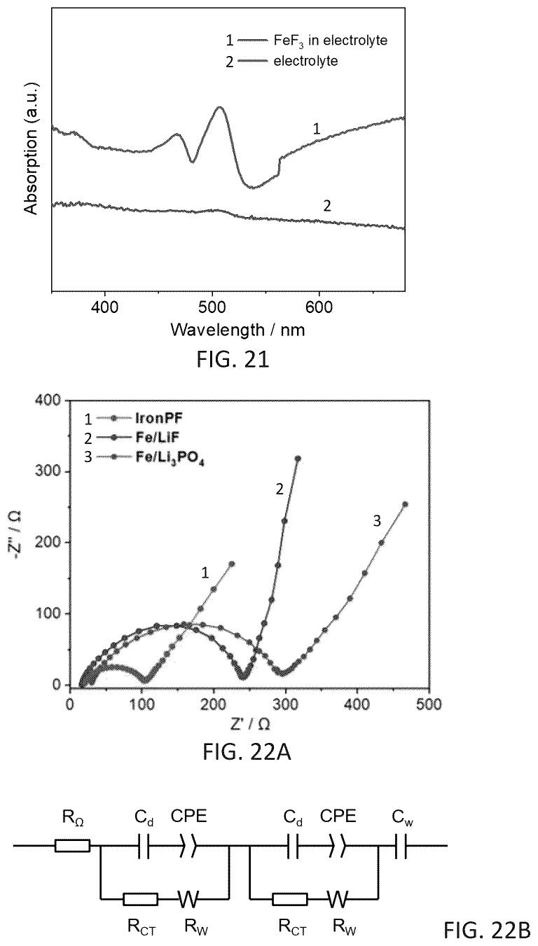

The next component with time constants between 1×10⁻⁴ s and 1×10⁻³ s should be ascribed to the lithium charge transfer resistance, R_{CT-Li}, based on the comparison with the GEIS results of the Li∥Li symmetric cell (FIG. 20B). It is worth emphasizing that the charge transfer of the LSC cathode is faster and involves a lower resistance of R_{CT-Li} than that of Li metal anode. Without wishing to be bound by a particular theory of operation, the fast kinetics of the LSC cathode is likely due to the concerted transport of Fe-ions, anions, and Li-ions. Intriguingly, this time constant is associated with the most conspicuous differences between the three LSC cathode half cells. Again, the IronPF electrode had a smaller R_{CT-Li} than the other two electrodes during both charge and discharge. IronPF showed a higher R_{CT-Li} during the charging process than its discharge. Interestingly, the RC time constant, τ, of the R_{CT-Li} for IronPF, decreased along the SoC of charging, which was initially similar to the longer τ for Fe/LiF and was later shortened to resemble the shorter τ for Fe/Li₃PO₄. The R_{CT-Li} for the Fe/Li₃PO₄ half cell was consistent, where the Li₃PO₄ may dissolve in the electrolyte and cover the surface of lithium metal anode. The R_{CT-Li} of the Fe/LiF half cell was much larger than the other two cells, and it progressively increased along cycling, which pertains to the larger solubility of FeF₃ in the electrolyte. As shown by the UV-Vis spectrum of the electrolyte in contact with FeF₃ (FIG. 21), FeF₃ is soluble in the EC/DEC electrolyte. It is interesting that the solid solution of FeFₓ/Fe₃(PO₄)ₓ is less soluble than FeFₓ.

Lastly, the DRT section with the largest time constant is attributed to the ion diffusion through solid-state phases by comparing the DRT results of half cells and symmetric cells, where again, Fe/LiF suffered higher resistance values than IronPF and Fe/Li₃PO₄. The solid solution of IronPF is likely a better conductor for all ion charge carriers, i.e., Fe-ions, anions, and Li-ions.

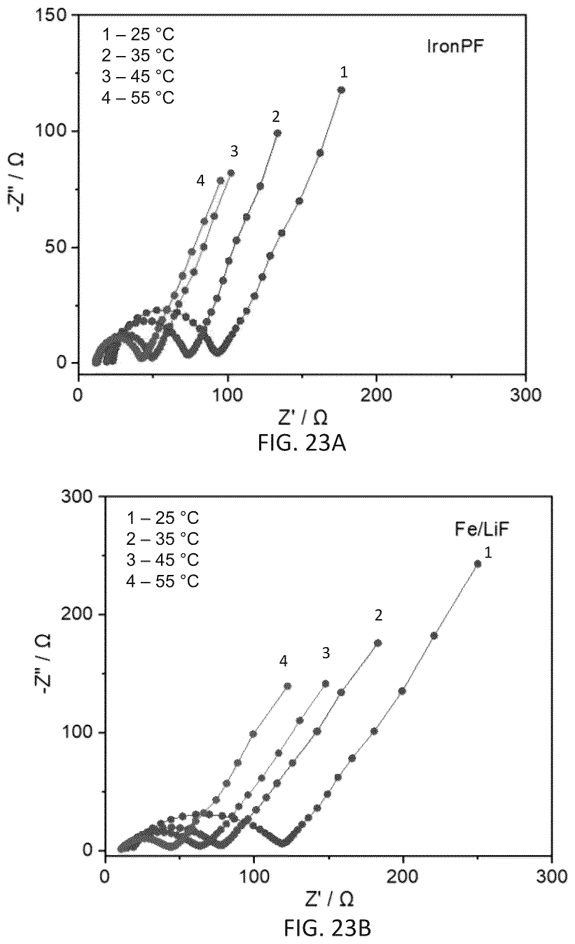

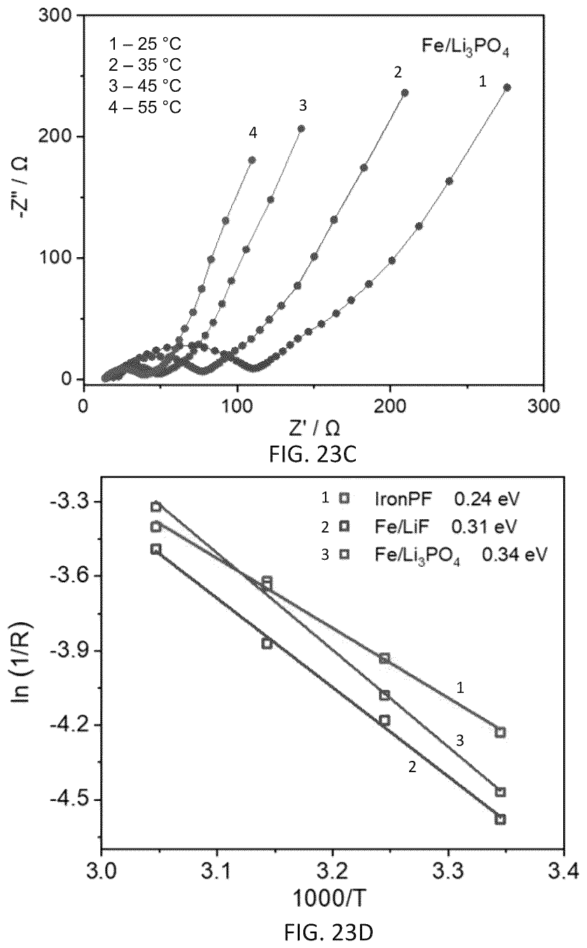

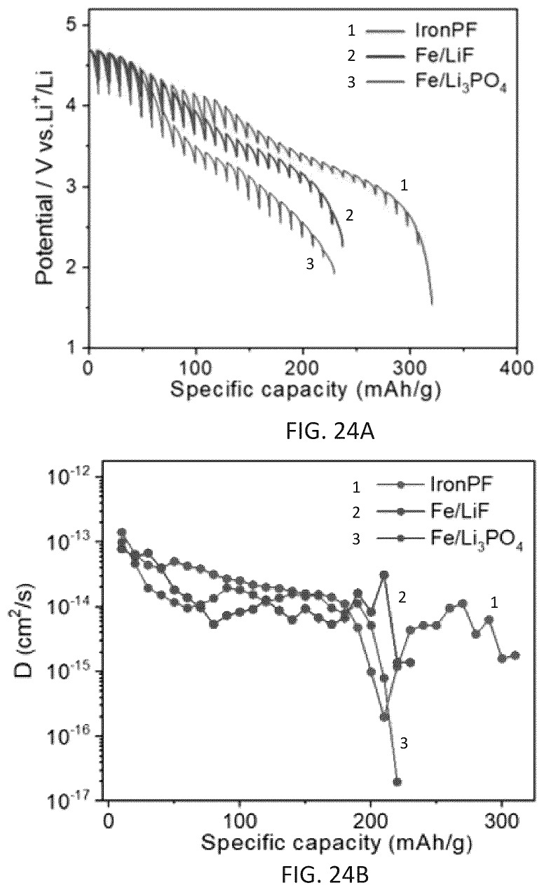

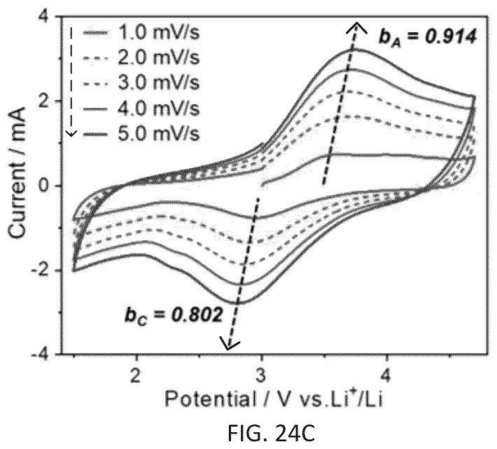

In situ EIS spectra were taken by using a potential amplitude at the middle potential between the paired anodic and cathodic peaks in cyclic voltammetry (CV), where the solid solution of IronPF also exhibits a smaller R_{CT} of 64 S/cm than that of Fe/LiF (163 S/cm) and Fe/Li₃PO₄ (230 S/cm). The lower R_{CT} was contributed by the faster transport of ions (FIGS. 22A, 22B). Based on the EIS spectra collected at different temperatures, IronPF exhibited the lowest calculated activation energy barrier compared with the other two composite electrodes (FIGS. 23A-23D). The galvanostatic intermittent titration technique (GITT) was used to examine the kinetics of the iron active mass within these salts during charging (FIG. 24A), where the solid solution of IronPF also exhibited a smaller overpotential compared to Fe/LiF and Fe/Li₃PO₄, whereas the diffusion coefficients of ions were estimated to be 10¹⁶−10⁻¹³ cm² s⁻¹ (FIG. 24C).

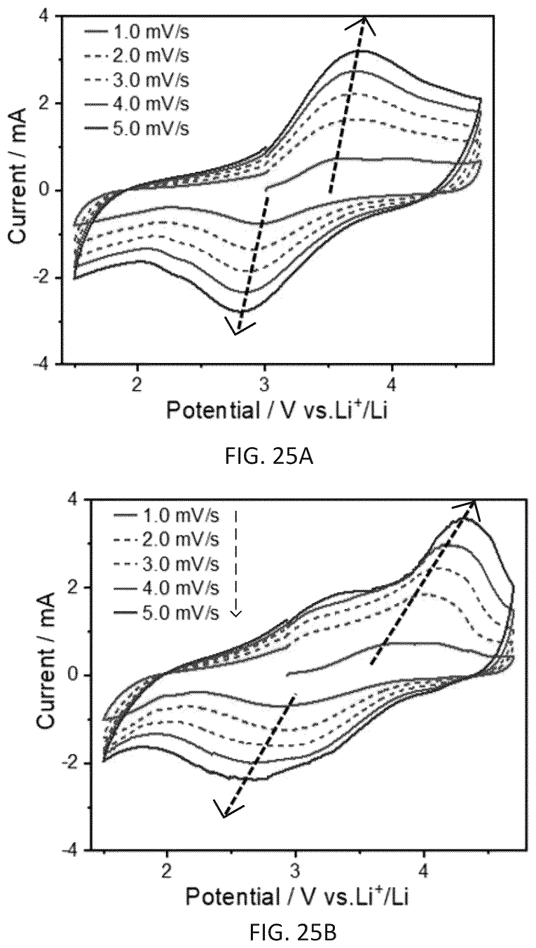

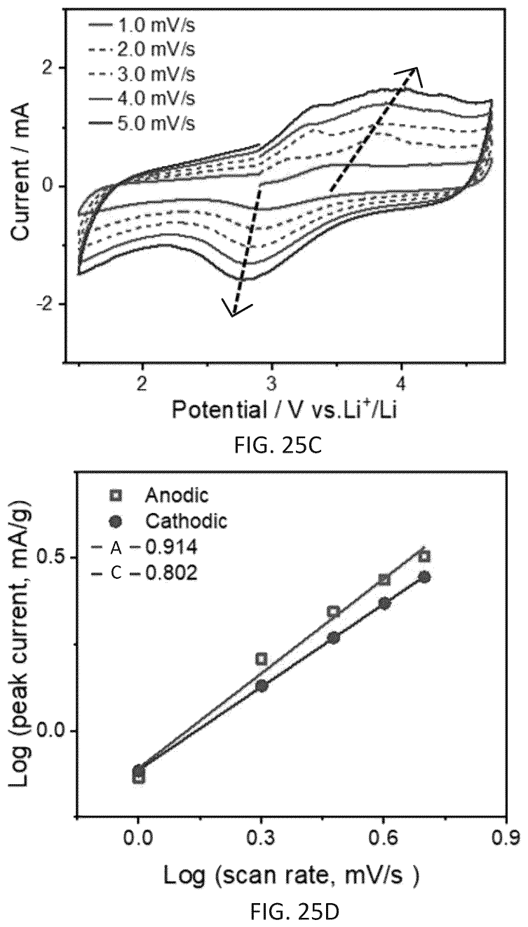

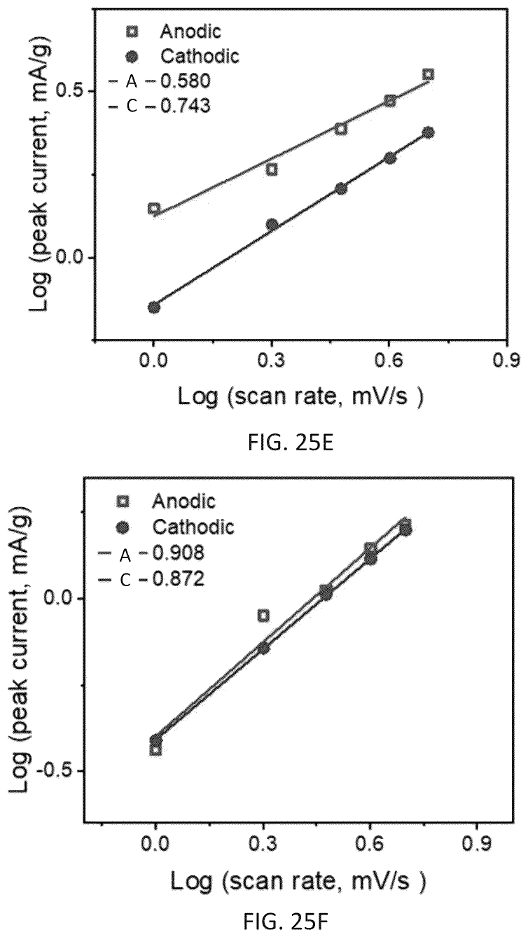

Cyclic voltammetry (CV) curves illustrated the redox behaviors of the iron active mass in the presence of these salts (FIGS. 25A-25C). With the CV curves collected at different scan rates, the b values were calculated in the equation of i=av^{b} for IronPF, Fe/LiF, and Fe/Li₃PO₄. When the scan rates were increased to 1 to 5 mV/s, the anodic peaks of IronPF and Fe/Li₃PO₄ remained non-diffusion-controlled with b values above 0.90, whereas the anodic conversion in Fe/LiF was overwhelmingly diffusion controlled by having b values below 0.6 (FIGS. 24C, 25D-25F). Interestingly, Fe/Li₃PO₄ exhibited the highest b value of the cathodic peak, which is consistent with the finding that Li-ion transport is faster in the amorphous Li₃PO₄ (Ohnishi et al., ACS Omega 2022, 7:21199-21206).

### Conclusion

Table 2 is a comparison of the properties of IronPF, LiFePO, LiNi_{0.8}Co_{0.1}Mn_{0.1}O₂ (NCM811), LiNi_{0.80}Co_{0.15}Al_{0.05}O₂ (NCA), and LiCoO₂ (LCO) cathodes. The properties were determined at room temperature unless otherwise specified. The electrochemical parameters are obtained from Lyu et al. (Adv. Energy Mater. 2021, 11:2000982).

TABLE 2

| | Capacity | Potential | Energy density |
|---|---|---|---|
| | (mAh/g) | (V vs Li⁺/Li) | (Wh/kg) |
| IronPF | 285 | 2.8 | 798 |
| | 367.8@60° C. | 2.56 | 942 |
| LiFePO₄ | 165 | 3.4 | 560 |
| LiNi_{0.8}Co_{0.1}Mn_{0.1}O₂ | 200 | 3.8 | 760 |
| NMC811 | | | |
| LiNi_{0.80}Co_{0.15}Al_{0.05}O₂ | 200 | 3.8 | 760 |
| NCA | | | |
| LiCoO₂ | 190 | 3.9 | 740 |
| LCO | | | |

The results demonstrated that in amorphous solids, anions and Fe ions play a role beyond being static components for framework construction; instead, they function as mobile charge carriers in the anodic conversion reaction from iron to its corresponding salts. Lithium salt cathodes that comprise an amorphous solid solution of anions transform the reactivity of iron active mass with enhanced utilization, faster reaction kinetics and transport of ions, and stable cycling. The findings open up a new approach centered on anion design to break the current energy density ceiling of Li-ion batteries set by nickel-based cathodes with sustainable Fe-based electrode materials.

### Example 3

Synthesis of Li₂CO₃·1/2Cu₂S, Li₂SO₄·1/2Cu₂S and Li₂CO₃/Li₂SO₄·Cu₂S composite. The Li₂CO₃·1/2Cu₂S, Li₂SO₄·1/2Cu₂S and Li₂CO₃/Li₂SO₄·Cu₂S composite was prepared with Li₂CO₃ (Fluka), Li₂SO₄ (ACROS ORGANICS), Cu₂S (Sigma-Aldrich), and KetjenBlack® carbon (EC600JD, MSE Supplies) without any prior purification. Li₂CO₃ and Cu₂S, Li₂SO₄ and Cu₂S, or Li₂CO₃, Li₂SO₄ and Cu₂S, in the molar ratio of 2:1, 2:1 and 1:1:1 were added to a planetary ball mill (Pulverisette® 6; Fritsch International, Pittsboro, NC) along with an additional 5.88 wt. % KetjenBlack® carbon. The mixture was sealed in an Ar-filled glovebox with H₂O and O₂ concentrations below 0.1 ppm. The powders in the bowl were subjected to ball milling at 400 r.p.m. for 50 hours, with a 5-minute break every 30 minutes.

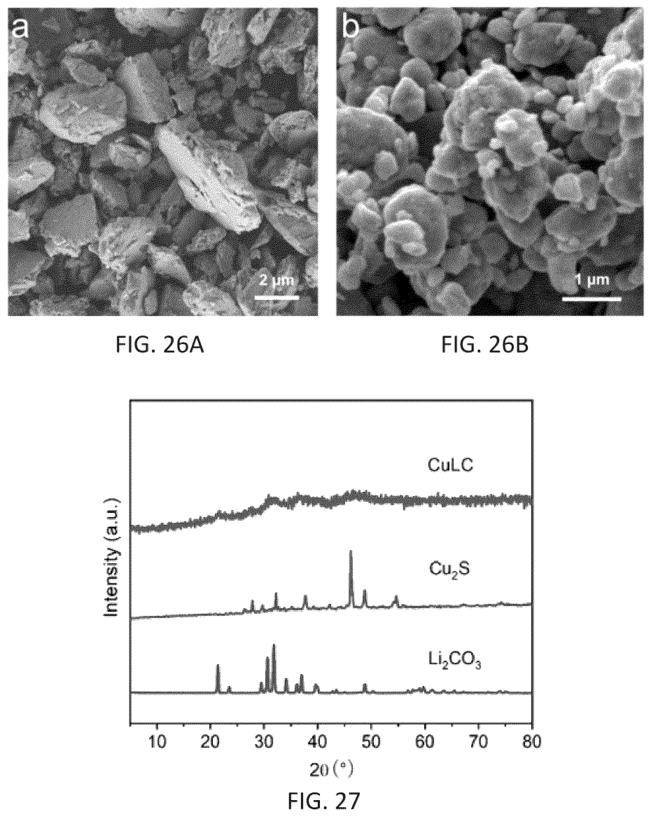

Cu₂S was assessed as an active cathode mass to utilize carbonate as charge compensating carriers. Being a natural mineral and the primary ore in the copper industry, Cu₂S has the potential to shed up to four electrons in an anodic reaction. Cu₂S and Li₂CO₃ were combined in a 1:2 molar ratio through ball milling, producing a composite electrode termed CuLC. The intention was to determine if the solid-phase diffusion of CO₃²⁻ ions occurs, potentially leading to the formation of insoluble CuCO₃ during the battery's charging process. The ball milling reduced the precursor particle sizes of Cu₂S and Li₂CO₃ from tens of microns to submicron averages, as shown in FIGS. 26A and 26B.

Subsequent X-ray diffraction (XRD) results revealed the amorphous nature of the resultant composite, erasing identifiable peaks in laboratory-scale XRD patterns of commercial Li₂CO₃, commercial Cu₂S, and the composite (FIG. 27). The results suggest that the composite includes nanocrystallites of Cu₂S and Li₂CO₃ that are a few nanometers in size.

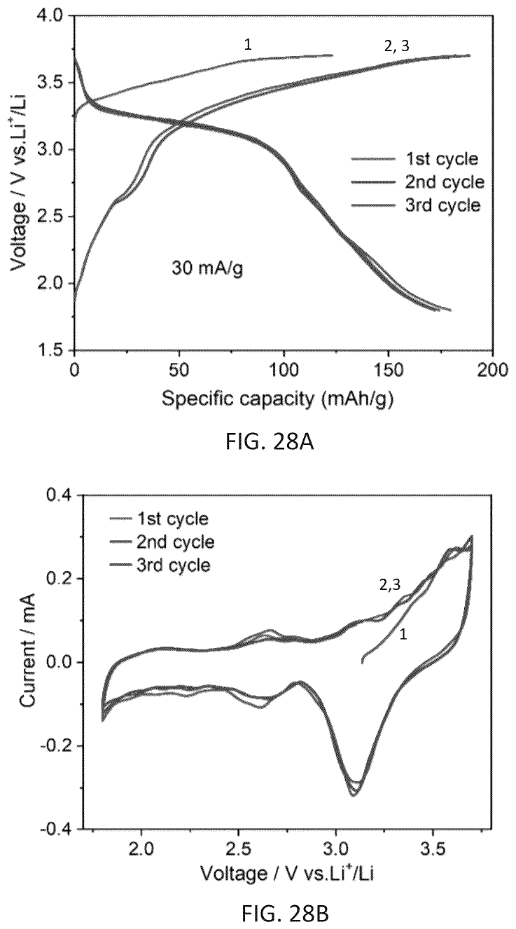

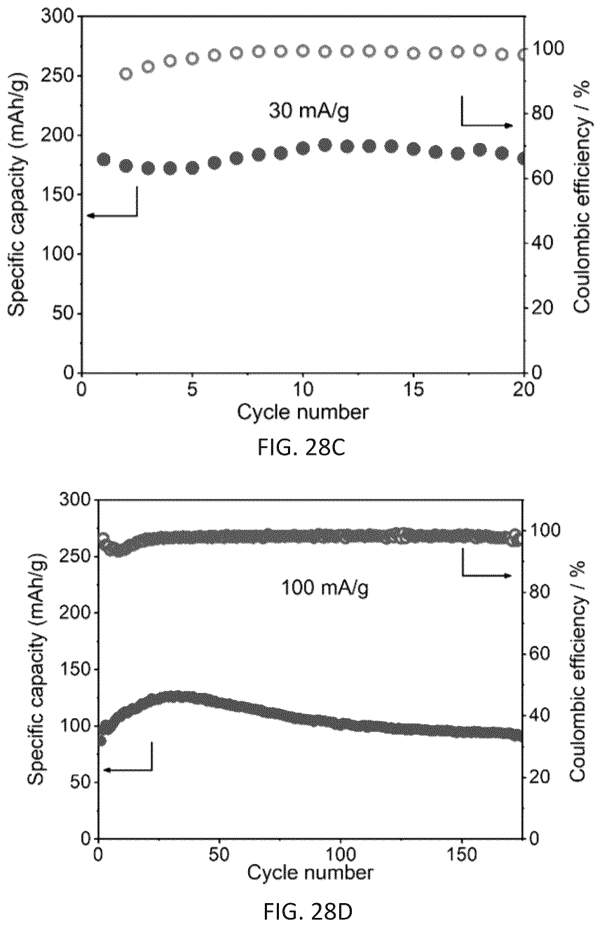

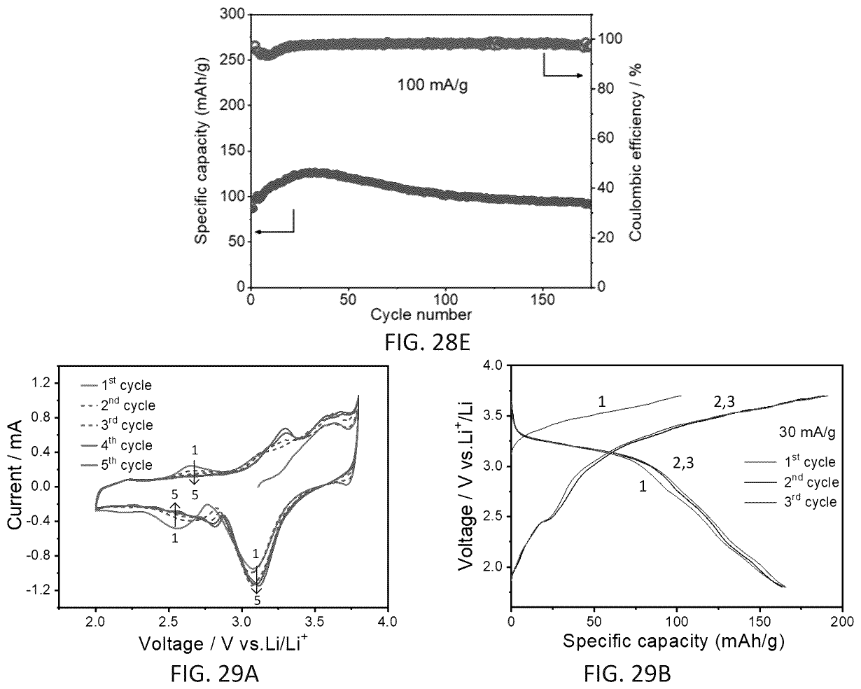

Upon its first galvanostatic charge, the CuLC demonstrates a capacity of 120 mAh/g, characterized by a plateau around 3.5 V (relative to Li⁺/Li and hereafter). The ensuing discharge displays a plateau centered at 3.2 V, followed by a gradual decline from 3.0 to 1.7 V. cumulatively yielding a capacity of 180 mAh/g, as shown in FIG. 28A. The cycle-cyclic voltammetry (CV) curve presented two pairs of anodic-cathodic peaks (FIG. 28B). The redox activity of the composite above 3.0 V is indicative of the reversible anodic process in the Cu₂S and 2Li₂CO₃ mixture, though the charge transfer stood at 1.27 e⁻. It is noteworthy that the discharge capacity beneath the initial open circuit voltage (OCV) of 3.1 V is likely the insertion of Li⁺ into the composite. The composite electrode maintained consistent cycling performance at both 30 mA/g and 100 mA/g, as illustrated in FIGS. 28C and 28D. FIG. 28E shows the cycling performance of the CuLC cathode in the coin cell at 100 mA/g over 175 cycles.

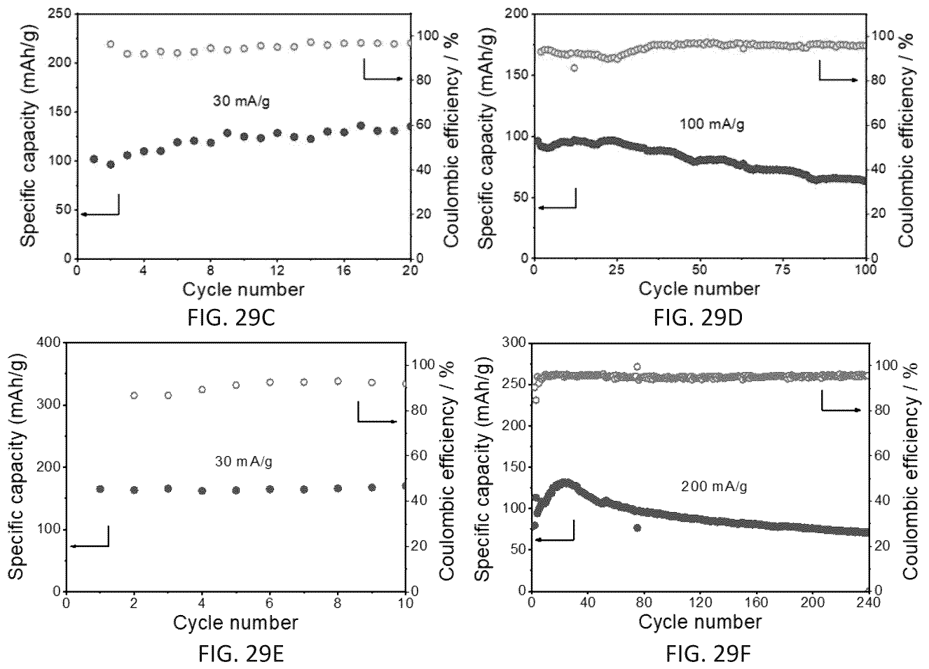

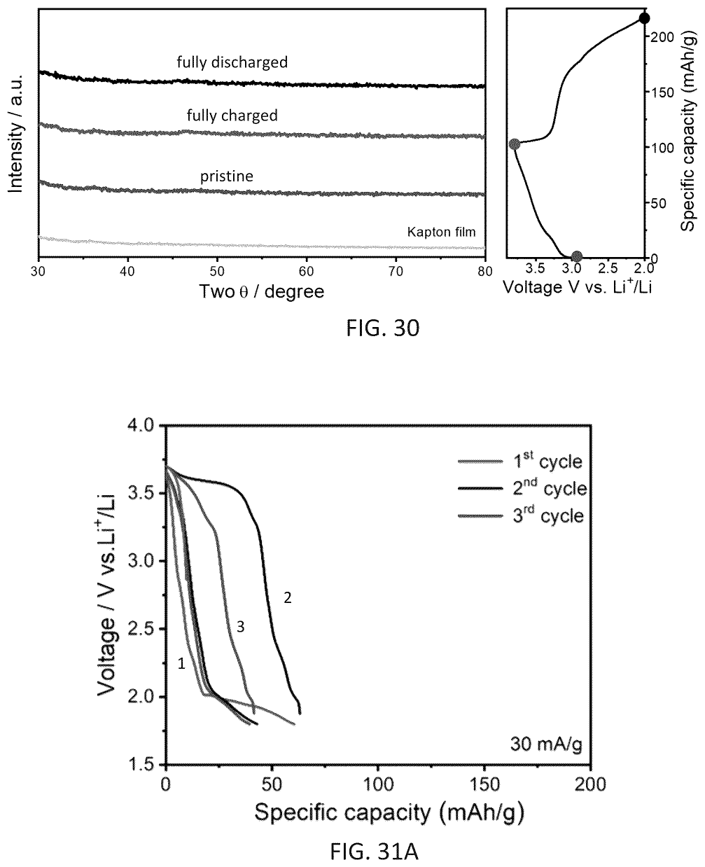

The electrochemical performance of the Li₂CO₃·1/2Cu₂S cathode was evaluated in two-electrode coin cells with lithium metal as the anode. The cutoff window was 2.0-3.8 V. A glass fiber membrane served as a separator, and Li metal was both the anode and the reference electrode. The electrolyte was 1.3 M LiTFSI in diglyme. The cyclic voltammetry curve of Li₂CO₃·1/2Cu₂S cathode exhibited two anodic peaks at 3.3 V and 3.8 V, two cathodic peaks at 3.1 V and 2.8 V (FIG. 29A). The Li₂CO₃·1/2Cu₂S cathode delivered a high discharge capacity of 102 mAh/g (based on the mass of Li₂CO₃ and Cu₂S) with a relatively high voltage plateau at 3.0 V at a current rate of 30 mA/g, and the discharge specific capacity increased gradually (FIGS. 29B, 29C). After 20 cycles, the discharge specific capacity was up to 135 mAh/g (FIG. 29C). At a higher current density of 100 mA/g, the Li₂CO₃·1/2Cu₂S cathode still delivers a discharge capacity of 96 mAh/g with relatively stable cycling life (FIG. 29D). A capacity retention of 66% was achieved after 100 cycles. In a trial of 10 cycles at 30 mA/g. the discharge specific capacity was up to 165 mAh/g (FIG. 29E). At very high current density of 200 mA/g. the Li₂CO₃·1/2Cu₂S cathode delivered a discharge capacity of ˜90 mAh/g with relatively stable cycling life (FIG. 29F). A capacity retention of ˜85% was achieved after 240 cycles. The Li₂CO₃·1/2Cu₂S composite retained an amorphous structure during the charging and discharging process in 1.3 M LiTFSI in diglyme over a voltage window of 2.0-3.8 V, confirmed by the ex situ XRD patterns of the pristine, fully charged and fully discharged Li₂CO₃·1/2Cu₂S cathode (FIG. 30).

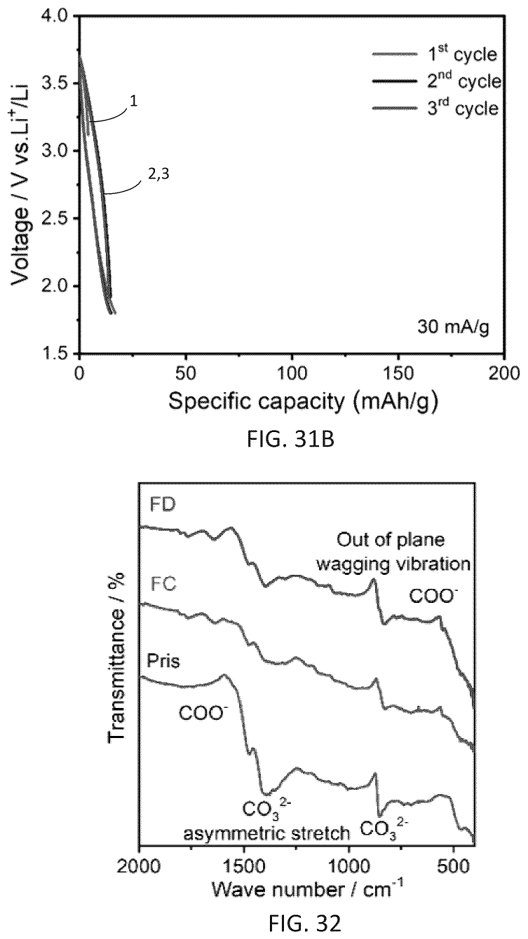

Given that Cu₂S does not contribute to the observed capacity, the next inquiry pertained to the component within the CuLC composite that acts as the primary electron source during anodic charging. One postulation was that the sulfide (−2) could act as the redox center. To validate this, an electrode of Cu₂S, devoid of any Li₂CO₃, was synthesized through ball milling with the carbon additive KetjenBlack® carbon black (AkzoNobel N.V., Amsterdam, Netherlands). When subjected to testing, this pure Cu₂S electrode yielded an initial charge capacity of merely 12 mAh/g under analogous conditions. The subsequent discharge demonstrated a capacity of 60 mAh/g, characterized by a plateau below 2 V (FIG. 31A). Upon excluding both Cu(I) and sulfide as potential contributors, the CO₃²⁻ ions emerged as the electron source. This observation led to an investigation of whether Li₂CO₃ could singularly account for the noted capacity in the absence of Cu₂S. An electrode comprised solely of Li₂CO₃ ball milled with KetjenBlack® carbon black exhibited negligible charging and discharging capacities (FIG. 31B). These findings strongly suggest a synergistic relationship between Cu₂S and Li₂CO₃, rendering the composite redox-active, with Cu₂S catalyzing the redox activity of CO₃²⁻ ions.

The Fourier transform infrared spectra (FTIR) revealed a diminished intensity in the CO₃²⁻ peaks, accompanied by a slight redshift post the initial charge. This alteration can be attributed to the oxidation of CO₃²⁻, which consequently attenuates the covalent bonds between the carbon and oxygen atoms. Upon discharge, the peaks corresponding to CO₃²⁻ were substantially reinstated, indicating the reversible nature of the redox process (FIG. 32).

Given the catalytic reaction,

$$\\ {Li}_{2} {CO}_{3} {⟶}^{{Cu}_{2} S} {{Li}^{}}^{+} + {LiCO}_{3} + {e}^{-} ,$$

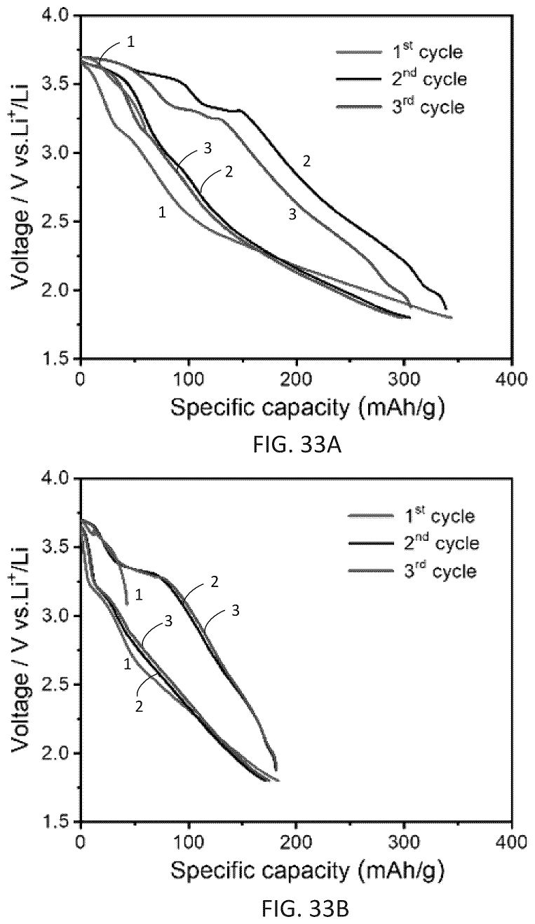

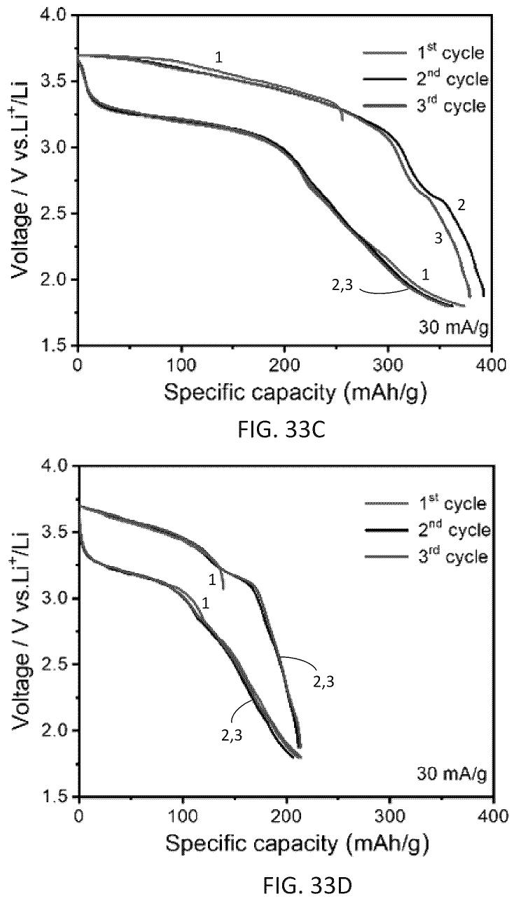

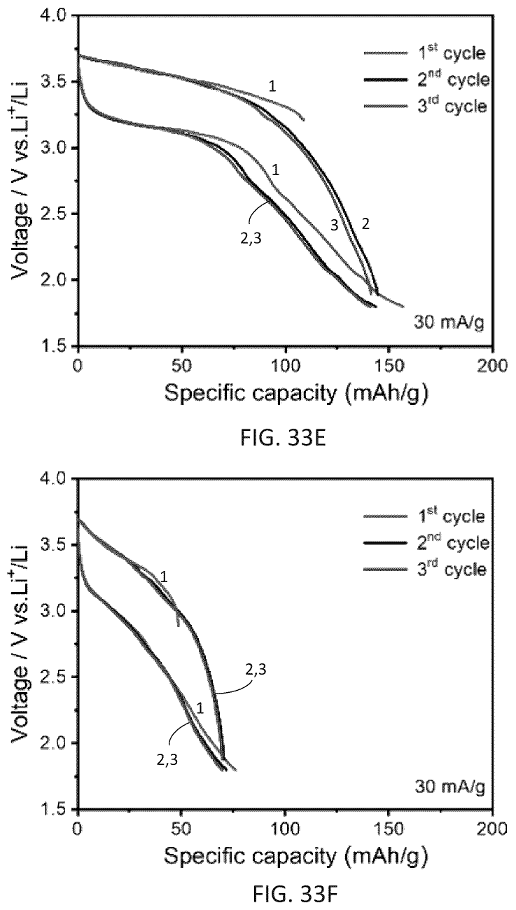

it may be beneficial to maximize the interface between Cu₂S and Li₂CO₃. Nevertheless, the anodic reaction involving Li₂CO₃ relies on both electronic and ionic conduction. Within such a composite, while both Cu₂S and KetjenBlack® (KB) carbon black provide electronic conductivity, an excessive concentration of Cu₂S and KB might hinder the conduction pathways for Li-ions. To discern the most advantageous ratio of Cu₂S to Li₂CO₃, initial charging capacities of composites were evaluated across various molar ratios, specifically 2:1, 1:1, 1:2. 1:4, 1:8, and 1:20 (FIGS. 33A-33F). The 1:2 ratio demonstrated the highest capacity for the entire composite, achieving a first charging capacity, based on the mass of Li₂CO₃, of 255 mAh/g—representing 70.3% of the theoretical capacity of 363 mAh/g for a single electron transfer. For ratios of Cu₂S to Li₂CO₃ less than 1:2, a limited fraction of carbonate ions interfaced with Cu₂S, thereby restricting carbonate oxidation. Notably, the capacity, when normalized by the mass of Li₂CO₃, did not show further enhancement even with an increased Cu₂S catalyst proportion at molar ratios of 1:1 and 2:1. These findings suggest that an excessive amount of Cu₂S can obstruct the ionic conduction of Li-ions, precluding the electrochemical oxidation of CO₃²⁻ ions.

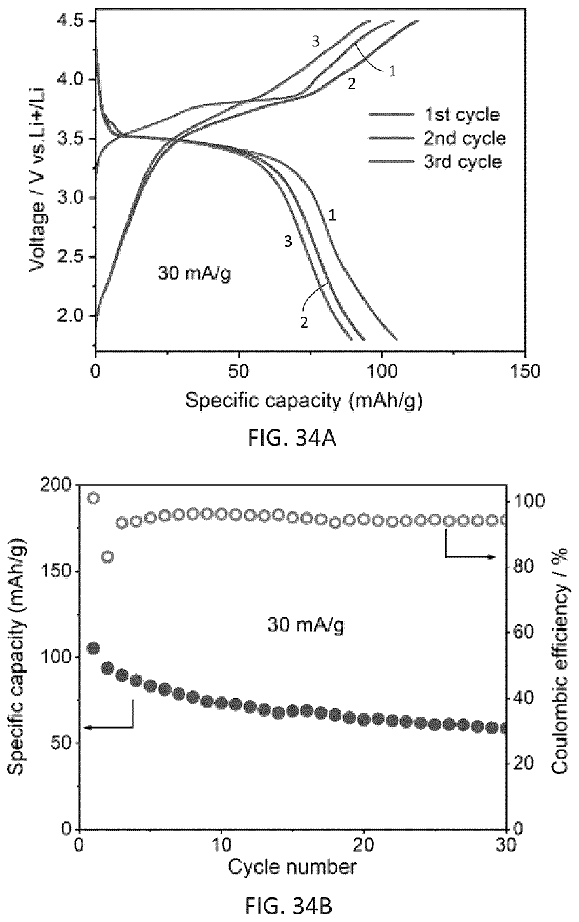

The above results underscore the pivotal role of Li-ion ionic conduction in facilitating anion oxidation. Notwithstanding, it is recognized that Li₂CO₃ does not excel as a Li-ion conductor. This prompted an investigation of whether the Li-ion conduction of this composite could be enhanced by introducing another lithium salt known for superior Li-ion conductivity. Li₂SO₄ was incorporated as a co-salt, given its documented high Li-ion conductivity (Nagao et al., Sci. Adv., Jun. 19, 2020, 6(25):eaax7236). As a control electrode, a composite comprising Cu₂S and Li₂SO₄, designated as CuLS, was synthesized and subjected to GCD analysis (FIGS. 34A-34B). Notably, the charge process of this composite exhibited a capacity of 110 mAh/g, and the ensuing discharge manifested a higher mean potential in comparison to the CuLC composite, characterized by a plateau proximate to 3.5 V. Nevertheless, a more pronounced capacity degradation was observed for CuLS compared to CuLC, which can likely be attributed to the high solubility of Li₂SO₄ in the LiPF₆ electrolyte, solvated in ethylene carbonate (EC) and diethyl carbonate (DEC).

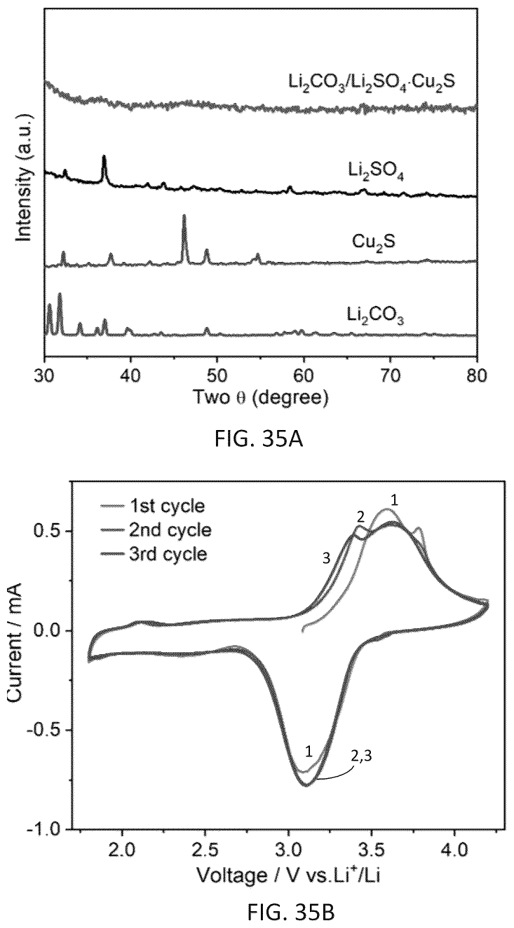

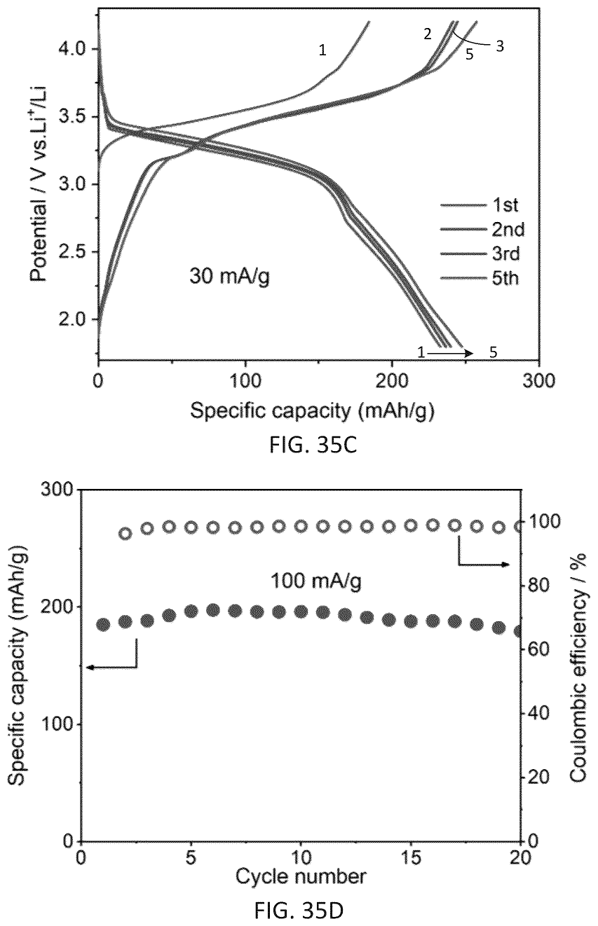

Subsequently, a ternary composite incorporating Cu₂S, Li₂CO₃, and Li₂SO₄ in an equimolar ratio (1:1:1) was synthesized, denoted as CuLCS. The XRD patterns (FIG. 35A) indicated the formation of an amorphous phase within the composite. Theoretically, the atomic mixing of Li₂CO₃ and Li₂SO₄ yields an amorphous Li₄CO₃SO₄ compound. Distinctively, the electrochemical profiling of CuLCS differed from both CuLC and CuLS (FIGS. 35B-35D). The charging and discharging potentials were intermediate (FIG. 42C), rather than having two sequential plateaus. The singular plateau indicates a homogenous chemical environment, corroborating Li₄CO₃SO₄ as a new compound. Notably, CuLCS demonstrated a superior capacity, reaching up to 245 mAh/g at an average discharge voltage of 3.0 V (FIG. 35D), thus offering a specific energy of 735 Wh/kg. It is noteworthy that the active mass loading exceeded 12 mg/cm², comparable to commercial battery standards. Without any electrode engineering in our preliminary studies, it is conceivable that this novel electrode chemistry could achieve even greater specific energy outputs. Intriguingly, CuLCS did not exhibit the same capacity degradation observed in CuLS, implying that the Li₄CO₃SO₄ lattice preserves the insolubility characteristic of Li₂CO₃. This further accentuates the distinct properties of Li₄CO₃SO₄ as a novel compound, wherein the fraction of Li₂SO₄ remains undissolved.

Both CO₃²⁻ and SO₄²⁻ demonstrated a degree of reversible redox activity when paired with Cu₂S and can function as redox centers. The data indicates that the oxidation state of Cu (I) remains consistent throughout the cycling process (i.c., Cu₂S is redox-inert), suggesting its role as a catalyst. Both Li₂CO₃ and Li₂SO₄ can serve as the active mass, where the oxidation of these anions is charge-compensated by the expulsion of Li-ions. The ball-milled combinations of Cu₂S+Li₂CO₃ and Cu₂S+Li₂SO₄ displayed reversible capacity, undergoing delithiation where the anions underwent oxidation. Intriguingly, the Li₂CO₃ and Li₂SO₄ solid solution, or blend, presented a synergistic redox reaction as evidenced by significantly enhanced capacity. The composite electrode yielded a specific discharge capacity of 245 mAh/g, based on the entire mass of Cu₂S:Li₄CO₃SO₄ composite. Of this, 182 mAh/g originated from the initial charge, while the residual capacity is attributed to the Li⁺ incorporation into the composite. This new composite cathode's energy density stands at 735 Wh/kg, rivaling the expensive LiNiₓCo_{y}Al_{z}O₂ (NCA) and LiNiₓMn_{y}Co_{z}O₂ (NMC) electrodes.

### Example 4

Full Cell with a Cu₂S/Li₂CO₃/Li₂SO₄ Composite Cathode

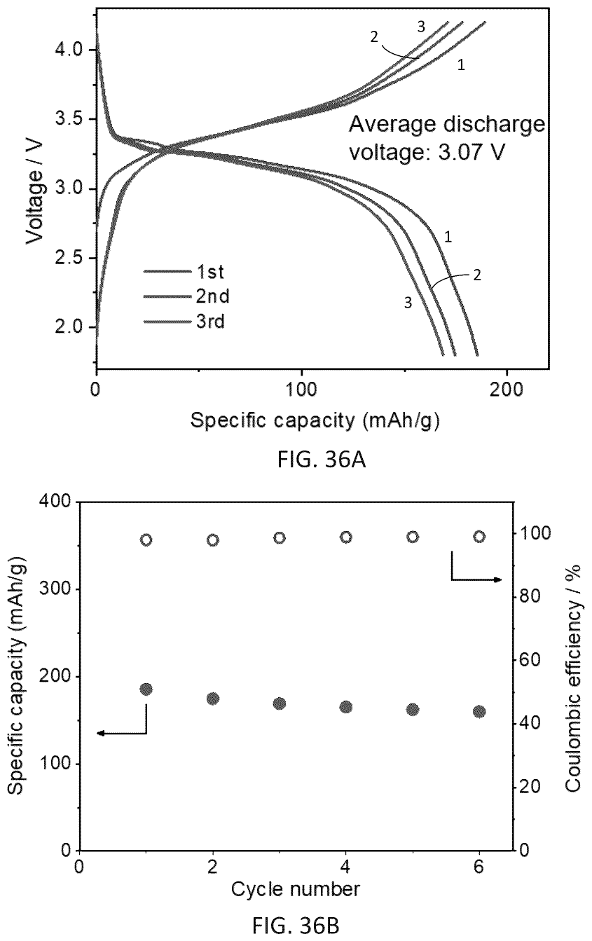

A full cell was constructed with a cathode comprising a ternary composite of Cu₂S, Li₂CO₃, and Li₂SO₄, with a Li₂CO₃:Li₂SO₄ molar ratio of 1:2. The composite comprised 24.0 wt % Cu₂S, 56 wt % Li₂CO₃+Li₂SO₄, 10 wt % conducting carbon, and 10 wt % PTFE binder. The active mass of the cathode was the mass of Cu₂S, Li₂CO₃, and Li₂SO₄. The cathode was a free-standing film with an areal mass loading of ˜13.5 mg/cm². The anode was graphite, a standard anode for Li-ion batteries, with an areal mass loading of 7.1 mg/cm−2− and a specific capacity of 350 mAh/g. The anode/cathode capacity ratio (N/P ratio) was 1:1. The electrolyte consisted of 1.0 M LiPF₆+0.1 M LiDFOB in EC/DEC (1:1). The full cell was cycled at a current rate of 30 mA/g. based on the cathode active mass. The cell was charged first. FIGS. 36A and 36B show the charge-discharge voltage profiles for the first three cycles (FIG. 36A) and the initial cycling life over 6 cycles at 30 mA/g (FIG. 36B). The capacity is based on the cathode active mass. The first discharge specific capacity was 185.4 mAh/g with an energy density of 569 Wh/kg based on the cathode active mass and 372 Wh/kg based on the combined mass of the cathode active mass and the anode active mass.

In view of the many possible embodiments to which the principles of the disclosure may be applied, it should be recognized that the illustrated embodiments are only preferred examples of the disclosure and should not be taken as limiting the scope of the invention. Rather, the scope of the invention is defined by the following claims. We therefore claim as our invention all that comes within the scope and spirit of these claims.

We claim:

1. A cathode, comprising:
a composite of
(i) a first component comprising one or more metal salts, wherein each metal salt is an alkali metal salt or an alkaline earth metal salt comprising M where M is Li, Na, K, Mg, Ca, or any combination thereof;
(ii) a second component comprising Cu₂S, Cu₂O, Cu, Fe, MnCO₃, MnF₂, Mn, Ni, Co, V, Cr, FeS, FeS₂, or any combination thereof; and
(iii) a third component comprising a carbon additive.

2. The cathode of claim 1, wherein:
(i) M is Li, Na, K, or any combination thereof, and the cathode has
an M:Cu₂S molar ratio of 2 to 8, or
an M:Cu₂O molar ratio of 2 to 8, or
an M:Cu molar ratio of 1 to 4, or
an M:Fe molar ratio of 1 to 6, or
an M:MnCO₃ molar ratio of 1 to 4, or
an M:MnF₂ molar ratio of 1 to 4, or
an M:Mn molar ratio of 2 to 8, or
an M:Ni molar ratio of 2 to 8, or
an M:Co molar ratio of 1 to 6, or
an M:V molar ratio of 2 to 10, or
an M:Cr molar ratio of 1 to 6, or
an M:FeS molar ratio of 1 to 6, or
an M:FeS₂ molar ratio of 1 to 6, or
any combination thereof; or
(ii) M is Mg, Ca, or a combination thereof, and the cathode has
an M:Cu₂S molar ratio of 1 to 4, or
an M:Cu₂O molar ratio of 1 to 4, or
an M:Cu molar ratio of 0.5 to 2, or
an M:Fe molar ratio of 0.5 to 3, or
an M:MnCO₃ molar ratio of 0.5 to 2, or
an M:MnF₂ molar ratio of 0.5 to 2, or
an M:Mn molar ratio of 1 to 4, or
an M:Ni molar ratio of 1 to 4, or
an M:Co molar ratio of 0.5 to 3, or
an M:V molar ratio of 1 to 5, or
an M:Cr molar ratio of 0.5 to 3, or
an M:FeS molar ratio of 0.5 to 3, or
an M:FeS₂ molar ratio of 0.5 to 3, or
any combination thereof.

3. The cathode of claim 1, wherein the first component comprises:
(i) Li₃BO₃, Li₂CO₃, Li₃PO₄, LiOH, HCOOLi, CH₃COOLI, LIF, LiCl, LiBr, LiHCO₃, Li₂SO₄, Li₂SO₃, LiHSO₄, Li₂HPO₄, LiH₂PO₄, LiNO₃, LiClO₃, LiClO₄, or any combination thereof; or
(ii) Na₃BO₃, Na₂CO₃, Na₃PO₄, NaOH, HCOONa, CH₃COONa, NaF, NaCl, NaBr, NaHCO₃, Na₂SO₄, Na₂SO₃, NaHSO₄, Na₂HPO₄, NaH₂PO₄, NaNO₃, NaClO₃, NaClO₄, or any combination thereof; or
(iii) K₃BO₃, K₂CO₃, K₃PO₄, KOH, HCOOK, CH₃COOK, KF, KCl, KBr, KHCO₃, K₂SO₄, K₂SO₃, KHSO₄, K₂HPO₄, KH₂PO₄, KNO₃, KClO₃, KClO₄, or any combination thereof; or
(iv) Mg₃(BO₃)₂, MgCO₃, Mg₃(PO₄)₂, Mg(OH)₂, (HCOO)₂Mg, (CH₃COO)₂Mg, MgF₂, MgCl₂, MgBr₂, Mg(HCO₃)₂, MgSO₄, MgSO₃, Mg(HSO₄)₂, MgHPO₄, Mg(H₂PO₄)₂, Mg(NO₃)₂, Mg(ClO₃)₂, Mg(ClO₄)₂, or any combination thereof; or
(v) Ca₃(BO₃)₂, CaCO₃, Ca₃(PO₄)₂, Ca(OH)₂, (HCOO)₂Ca, (CH₃COO)₂Ca, CaF₂, CaCl₂, CaBr₂, Ca(HCO₃)₂, CaSO₄, CaSO₃, Ca(HSO₄)₂, CaHPO₄, Ca(H₂PO₄)₂, Ca(NO₃)₂, Ca(ClO₃)₂, Ca(ClO₄)₂, or any combination thereof.

4. The cathode of claim 1, comprising:
(i) Fe and MₓA_{y}, where MₓA_{y} is Mₓ(PO₄)_{y} MₓFy, or a combination thereof; or
(ii) Cu₂S and MₓA_{y}, where MₓA_{y} is Mₓ(CO₃)_{y}, Mₓ(SO₄)_{y}, Mₓ(SO₃)_{y}, Mₓ(PO₄)_{y}, Mₓ(OH)_{y}, (HCOO)_{y}Mₓ, (CH₃COO)_{y}Mₓ, or any combination thereof; or
(ii) Cu and MₓA_{y}, where MₓA_{y} is Mₓ(CO₃)_{y}, Mₓ(PO₄)_{y}, or a combination thereof; or
(iii) MnCO₃ and MₓA_{y}, where MₓA_{y} is Mₓ(CO₃),
where x and y are integers representing the stoichiometric ratio of M and A.

5. The cathode of claim 1, wherein M is Li or Na.

6. The cathode of claim 1, further comprising a binder, conductive carbon, or a binder and conductive carbon.

7. The cathode of claim 6, wherein the binder comprises polytetrafluoroethylene, polyvinyl alcohol, polyvinyl chloride, polyvinyl fluoride, ethylene oxide polymers, polyvinylpyrrolidone, polyurethane, polyvinylidene fluoride, polyethylene, polypropylene, styrene-butadiene rubber, epoxy resin, nylon, or any combination thereof.

8. The cathode of claim 6, comprising 70 wt % to 97 wt % of the composite, 2 wt % to 15 wt % of the binder, and 1 wt % to 15 wt % of the conductive carbon.

9. The cathode of claim 8, wherein the binder comprises polytetrafluoroethylene and the conductive carbon comprises carbon black.

10. The cathode of claim 1, further comprising a current collector.

11. A battery, comprising:
a cathode according to claim 1;
an anode; and
an electrolyte.

12. The battery of claim 11 wherein the anode comprises lithium metal, sodium metal, potassium metal, magnesium metal, calcium metal, graphite, silicon, SiO, a Si/C composite, Li₄Ti₅O₁₂, a transition metal oxide, a transition metal sulfide, a tin-based anode, or an antimony-based anode.

13. The battery of claim 11, wherein the electrolyte comprises:
a lithium salt, a sodium salt, a potassium salt, a magnesium salt, or a calcium salt, wherein the lithium salt, sodium salt, potassium salt, magnesium salt, or calcium salt is different than the one or more metal salts of the cathode; and
a solvent.

14. The battery of claim 13, wherein:
(i) the lithium salt comprises LiPF₆, lithium bis(trifluoromethanesulfonyl)imide (LiTFSI), lithium bis(fluorosulfonyl)imide (LiFSI), lithium bis(oxalato)borate (LiB(C₂O₄)₂, LiBOB), lithium difluoro(oxalato)borate (LiBF₂(C₂O₄), LiDFOB), LiCF₃SO₃, LiAsF₆, LiBF₄, LiSCN, lithium bis(pentafluoroethanesulfonyl)imide (LiN(SO₂CF₂CF₃)₂, LiBETI), lithium (fluorosulfonyl trifluoromethanesulfonyl)imide (LiN(SO₂F)(SO₂CF₃), LIFTFSI), lithium (fluorosulfonyl pentafluoroethanesulfonyl)imide (LiN(SO₂F)N(SO₂CF₂CF₃), LiFBETI), lithium cyclo(tetrafluoroethylenedisulfonyl)imide (LiN(SO₂CF₂CF₂SO₂), LiCTFSI), lithium (trifluoromethanesulfonyl)(n-nonafluorobutanesulfonyl)imide (LiN(SO₂CF₃)(SO₂-n-C₄F₉), LiTNFSI), or any combination thereof; or
(ii) the sodium salt comprises NaPF₆, sodium bis(trifluoromethanesulfonyl)imide (NaTFSI), sodium bis(fluorosulfonyl)imide (NaFSI), sodium bis(oxalato)borate (NaB(C₂O₄)₂, NaBOB), sodium difluoro(oxalato)borate (NaBF₂(C₂O₄), NaDFOB), NaCF₃SO₃, NaAs₆, NaBF₄, NaSCN, sodium bis(pentafluoroethanesulfonyl)imide (NaN(SO₂CF₂CF₃)₂, NaBETI), sodium (fluorosulfonyl trifluoromethanesulfonyl)imide (NaN(SO₂F)(SO₂CF₃), NaFTFSI), sodium (fluorosulfonyl pentafluoroethanesulfonyl)imide (NaN(SO₂F)N(SO₂CF₂CF₃), NaFBETI), sodium cyclo(tetrafluoroethylenedisulfonyl)imide (NaN(SO₂CF₂CF₂SO₂), NaCTFSI), sodium (trifluoromethanesulfonyl)(n-nonafluorobutanesulfonyl)imide (NaN(SO₂CF₃)(SO₂-n-C₄F₉), NaTNFSI), or any combination thereof; or
(iii) the potassium salt comprises KPF₆, potassium bis(trifluoromethanesulfonyl)imide (KTFSI), potassium bis(fluorosulfonyl)imide (KFSI), potassium bis(oxalato)borate (KB(C₂O₄)₂, KBOB), potassium difluoro(oxalato)borate (KBF₂(C₂O₄), KDFOB), KCF₃SO₃, KAsF₆, KBF₄, KSCN, potassium bis(pentafluoroethanesulfonyl)imide (KN(SO₂CF₂CF₃)₂, KBETI), potassium (fluorosulfonyl trifluoromethanesulfonyl)imide (KN(SO₂F)(SO₂CF₃), KFTFSI), potassium (fluorosulfonyl pentafluoroethanesulfonyl)imide (KN(SO₂F)N(SO₂CF₂CF₃), KFBETI), potassium cyclo(tetrafluoroethylenedisulfonyl)imide (KN(SO₂CF₂CF₂SO₂), KCTFSI), potassium (trifluoromethanesulfonyl)(n-nonafluorobutanesulfonyl)imide (KN(SO₂CF₃)(SO₂-n-C₄F₉), KTNFSI), or any combination thereof; or
(iv) the magnesium salt comprises Mg(PF₆)₂, magnesium bis(trifluoromethanesulfonyl)imide (MgTFSI), magnesium bis(fluorosulfonyl)imide (MgFSI), magnesium bis(oxalato)borate (Mg[B(C₂O₄)₂]₂, MgBOB), magnesium difluoro(oxalato)borate (Mg[BF₂(C₂O₄)]₂, MgDFOB), Mg(CF₃SO₃)₂, Mg(AsF₆)₂, Mg(BF₄)₂, Mg(SCN)₂, magnesium bis(pentafluoroethanesulfonyl)imide (Mg[N(SO₂CF₂CF₃)₂]₂, MgBETI), magnesium (fluorosulfonyl trifluoromethanesulfonyl)imide (Mg[N(SO₂F)(SO₂CF₃)]₂, MgFTFSI), magnesium (fluorosulfonyl pentafluoroethanesulfonyl)imide (Mg[N(SO₂F)N(SO₂CF₂CF₃)]₂, MgFBETI), magnesium cyclo(tetrafluoroethylenedisulfonyl)imide (Mg [N(SO₂CF₂CF₂SO₂)]₂, MgCTFSI), magnesium (trifluoromethanesulfonyl)(n-nonafluorobutanesulfonyl)imide (Mg[N(SO₂CF₃)(SO₂-n-C₄F₉)]₂, MgTNFSI), or any combination thereof; or
(v) the calcium salt comprises Ca(PF₆)₂, calcium bis(trifluoromethanesulfonyl)imide (CaTFSI), calcium bis(fluorosulfonyl)imide (CaFSI), calcium bis(oxalato)borate (Ca[B(C₂O₄)₂]₂, CaBOB), calcium difluoro(oxalato)borate (Ca[BF₂(C₂O₄)]₂, CaDFOB), Ca(CF₃SO₃)₂, Ca(AsF₆)₂, Ca(BF₄)₂, Ca(SCN)₂, calcium bis(pentafluoroethanesulfonyl)imide (Ca[N(SO₂CF₂CF₃)₂]₂, CaBETI), calcium (fluorosulfonyl trifluoromethanesulfonyl)imide (Ca[N(SO₂F)(SO₂CF₃)]₂, CaFTFSI), calcium (fluorosulfonyl pentafluoroethanesulfonyl)imide (Ca[N(SO₂F)N(SO₂CF₂CF₃)]₂, CaFBETI), calcium cyclo(tetrafluoroethylenedisulfonyl)imide (Ca[N(SO₂CF₂CF₂SO₂)]₂, CaCTFSI), calcium (trifluoromethanesulfonyl)(n-nonafluorobutanesulfonyl)imide (Ca[N(SO₂CF₃)(SO₂-n-C₄F₉)]₂, CaTNFSI), or any combination thereof.

15. The battery of claim 13, wherein the solvent comprises ethylene carbonate (EC), dimethyl carbonate (DMC), 1,2-dimethoxyethane (DME), 2,2,2-trifluoroethyl-3′,3′,3′,2′,2′-pentafluoropropyl ether (HFE), diglyme (bis-2(methoxyethyl) ether), vinylene carbonate (VC), fluoroethylene carbonate (FEC), difluoroethylene carbonate (DFEC), trifluoroethylene carbonate (TFEC), vinyl ethylene carbonate (VEC), 4-methylene ethylene carbonate (MEC), propylene carbonate (PC), 4,5-dimethylene-1,3-dioxolan-2-one (butylene carbonate), ethyl methyl carbonate (EMC), diethyl carbonate (DEC), methyl 2,2,2-trifluoroethyl carbonate (MFEC), dimethyl sulfone (DMS), ethyl methyl sulfone (EMS), ethyl vinyl sulfone (EVS), tetramethylene sulfone (TMS), trifluoromethyl ethyl sulfone (FMES), trifluoromethyl isopropyl sulfone (FMIS), trifluoropropyl methyl sulfone (FPMS), ethylene sulfite, ethylene sulfate, triglyme (triethylene glycol dimethyl ether), tetraglyme (tetraethylene glycol dimethyl ether), tetrahydrofuran (THF), 1-methoxy-2-propylamine, or any combination thereof.

16. A method of making a cathode according to claim 1, comprising:
combining (i) a first component comprising one or more anhydrous metal salts, wherein each anhydrous metal salt is an alkali metal salt or an alkaline earth metal salt comprising M where M is Li, Na, K, Mg, Ca, or any combination thereof, (ii) a second component comprising Cu₂S, Cu₂O, Cu, Fe, MnCO₃, MnF₂, Mn, Ni, Co, V, Cr, FeS, FeS₂, or any combination thereof, and (iii) a third component comprising a carbon additive to form a mixture; and
milling the mixture to form a composite.

17. The method of claim 16, wherein:
(i) the first component is a Li salt, a Na salt, a K salt, or any combination thereof, and is combined with the second component at
an M:Cu₂S molar ratio of 2 to 8, or
an M:Cu₂O molar ratio of 2 to 8, or
an M:Cu molar ratio of 1 to 4, or
an M:Fe molar ratio of 1 to 6, or
an M:MnCO₃ molar ratio of 1 to 4, or
an M:MnF₂ molar ratio of 1 to 4, or
an M:Mn molar ratio of 2 to 8, or
an M:Ni molar ratio of 2 to 8, or
an M:Co molar ratio of 1 to 6, or
an M:V molar ratio of 2 to 10, or
an M:Cr molar ratio of 1 to 6, or
an M:FeS molar ratio of 1 to 6, or
an M:FeS₂ molar ratio of 1 to 6, or
any combination thereof; or
(ii) the first component is a Mg salt, a Ca salt, or a combination thereof, and is combined with the second component at
an M:Cu₂S molar ratio of 1 to 4, or
an M:Cu₂O molar ratio of 1 to 4, or
an M:Cu molar ratio of 0.5 to 2, or
an M:Fe molar ratio of 0.5 to 3, or
an M:MnCO₃ molar ratio of 0.5 to 2, or
an M:MnF₂ molar ratio of 0.5 to 2, or
an M:Mn molar ratio of 1 to 4, or
an M:Ni molar ratio of 1 to 4, or
an M:Co molar ratio of 0.5 to 3, or
an M:V molar ratio of 1 to 5, or
an M:Cr molar ratio of 0.5 to 3, or
an M:FeS molar ratio of 0.5 to 3, or
an M:FeS₂ molar ratio of 0.5 to 3, or
any combination thereof.

18. The method of claim 16, further comprising combining the composite with a binder, conductive carbon, or a binder and conductive carbon to form a subsequent mixture.

19. The method of claim 18, wherein the mixture comprises 70 wt % to 97 wt % of the composite, 2 wt % to 15 wt % of the binder, and 1 wt % to 15 wt % of the conductive carbon.

20. The method of claim 18, further comprising applying the subsequent mixture to a current collector.
